(19) United States
(12) Patent Application Publication
(10) Pub. No.: US 2024/0383020 A1
(43) Pub. Date: Nov. 21, 2024

(54) ELECTROSTATIC SOOT CAPTURING PLATE ASSOCIATED WITH A BUILD CHAMBER OF A THREE-DIMENSIONAL (3-D) PRINTER

(71) Applicant: Divergent Technologies, Inc., Los Angeles, CA (US)

(72) Inventors: Finley Hugh MARBURY, Hermosa Beach, CA (US); Michael Thomas Kenworthy, Rancho Palos Verdes, CA (US)

(21) Appl. No.: 18/668,039

(22) Filed: May 17, 2024

Related U.S. Application Data
(60) Provisional application No. 63/503,443, filed on May 19, 2023.

(51) Int. Cl. B08B 15/00; B08B 6/00; B22F 10/32; B33Y 30/00; B33Y 40/00

(52) U.S. Cl. CPC B08B 15/00; B08B 6/00; B22F 10/32; B33Y 30/00; B33Y 40/00

(57) ABSTRACT

An apparatus and a method for attracting and/or repelling byproducts in a build chamber of a powder-bed fusion system by one or more electrostatically charged plates. The method and apparatus may deliver material to the build chamber of the powder-bed fusion system by a material depositor. An energy beam source may generate an energy beam and apply the energy beam to the material such that the energy beam generates byproducts in the build chamber when applied to the material. One or more electrostatically charged plates are associated with one or more walls of the build chamber to attract and/or repel at least a portion of the byproducts in the build chamber such that the byproducts attached to the surface of the electrostatically charged plates and/or exit the build chamber without damaging a build piece or components of the powder-bed fusion system.

### CROSS-REFERENCE TO RELATED APPLICATION

This application claims the benefit of U.S. Provisional Application No. 63/503,443 filed on May 19, 2023, entitled “Electrostatic Soot Capturing Plate in 3D Printer”, the entirety of which is incorporated by reference as if fully set forth herein.

### BACKGROUND

### Field

The present disclosure relates generally to removing contaminates (i.e., byproducts) such as particulates from a fluid and protecting structures from the byproducts within the fluid, and more specifically, a charged plate or plurality of plates attracting and/or repelling byproducts within a build chamber and/or a fluid such that the byproducts will be attracted to the plate(s) and/or away from a structure(s) or component(s) of a three-dimensional (3-D) printer and system in order to remove the byproducts from the fluid and/or build chamber and/or prevent the byproducts within the fluid from contacting the structure(s) and component(s) of the 3-D printer and system.

### Background

In three-dimensional 3-D printers and systems, such as powder-bed fusion (PBF) printers and systems, applying energy to powder within a build chamber of the 3-D printer creates contaminates/byproducts within the build chamber as the powder of the powder bed is being fused by the applied energy. The contaminates/byproducts may include, for example, particulates such as soot, smoke, gas(es), spatter, particles, elements, and other material from the fusion of the powder. The byproducts may deposit on one or more beam windows (i.e., beam entry windows) associated with the build chamber of a 3-D printer and/or system as well as other components of the 3-D printer and/or system and thus degrade the performance of the beam windows and the other components. Throughout the disclosure, contaminates and byproducts are synonymous terms and used interchangeably throughout this disclosure.

If the byproducts contact or interfere with, deposit on and/or attach to the beam entry windows, cleaning of the beam windows must occur in order to prevent degradation of the performance of the beam windows and the performance of the fusion process of the powder. Cleaning of the beam windows is very time consuming, labor intensive and is expensive due to unproductive stoppage time of the 3-D printer during the cleaning process. Additionally, the byproducts may impinge upon the powder and may contaminate the powder to be fused, thus creating defects in a part (i.e., build piece) being manufactured by the 3-D printer. Also, the byproducts may land on and attach to the build piece being manufactured causing defects within the build piece. A gas flow within the build chamber may remove some byproducts from the build chamber but not all of the byproducts generated by the fusion of the powder are removed from the build chamber by the gas flow and thus may cause build piece defects. Therefore, it is imperative to remove byproducts from the build chamber in order to avoid adverse printing effects that might corrupt the build piece and degrade components of the 3-D printer and system. More specifically, a byproduct free build chamber helps ensure that the material properties of the printed layers are clean and well-controlled, thus assuring the printed build piece possess predictable thermal and material properties.

### SUMMARY

In various example embodiments of the PBF system, one or more electrostatically charged plates remove byproducts from within the build chamber and/or prevent byproducts from contacting or interfering with, deposit on and/or attaching to a structure, components or various structures of the PBF system. For example, one or more electrostatically charged plates remove byproducts within the build chamber such that the byproducts are prevented from contaminating the powder and causing defects to the build piece. In another example, one or more electrostatically charged plates prevent byproducts within the build chamber from contacting the beam window(s). In various embodiments, various advantages may be realized as described in more detail below for various embodiments. For example, benefits may include maximizing the operational performance and efficiency of the PBF system, increasing the yield of part production and prevention of powder contamination, process instability and defects of the part being manufactured. Several aspects of the disclosed apparatuses and methods will be disclosed more fully hereinafter. The following summary of the one or more aspects of the disclosure are in order to provide a basic understanding of such aspects. This summary is not an extensive overview of all contemplated aspects and is intended to neither identify key or critical elements of all aspects nor delineate the scope of any or all aspects. Its purpose is to present some concepts of one or more aspects in a simplified form as a prelude to the more detailed description that is presented later.

In various example embodiments disclosed herein are apparatuses and methods of PBF systems. A three-dimension (3-D) printer may be any of the disclosed PBF systems or may include less components than any of the disclosed PBF systems.

In one or more embodiments, an apparatus for additive manufacturing includes a build chamber, a material depositor configured to deposit a material, an energy beam source configured to generate an energy beam and apply the energy beam to the material, the energy beam generates contaminants in the build chamber when applied to the material and an electrostatically charged plate is configured to attract or repel at least a portion of the contaminants in the build chamber. The material may include materials such as various metallic material, metallic powders, wires or rods. The various metallic material may include, for example, aluminum or alloys of aluminum. The electrostatically charged plate may include a plurality of electrostatically charged plates.

In one or more embodiments, the build chamber includes one or more walls such as side walls and a top wall and the electrostatically charged plate is integral with or coupled to the one or more walls.

In one or more embodiments, the apparatus further includes a beam entry window configured to pass the energy beam into the build chamber and the electrostatically charged plate is in a configuration to prevent the contaminants from depositing on the beam entry window.

In one or more embodiments, the apparatus further includes a first gas inlet configured to introduce a clean gas into the build chamber.

In one or more embodiments, the apparatus further includes a first gas outlet configured to remove at least a portion of a contaminated gas from the build chamber.

In one or more embodiments, the plurality of electrostatically charged plates is coupled to the one or more side walls and/or a top wall.

In one or more embodiments, the apparatus further includes a controller. The controller is configured to provide a first voltage on a first plate of the plurality of electrostatically charged plates and provide a second voltage on a second plate of the plurality of electrostatically charged plates. The first voltage may be the same or different from the second voltage. The controller may alternatively and/or additionally be configured to provide a voltage to one or more plates of the plurality of electrostatically charged plates to repel and/or attract the contaminants away from the beam entry window or a component of the PBF system.

In one or more embodiments, the plurality of electrostatically charged plates is positioned on or within the wall and arranged in an offset configuration, a grid configuration, or a non-parallel configuration. The offset configuration includes the plurality of electrostatically charged plates not horizontally aligned or not vertically aligned. A gap may be between a first plate and a second plate of the plurality of electrostatically charged plates or between any two or more plates.

In one or more embodiments, the top wall includes a beam entry window configured to pass the energy beam into the build chamber. The top wall may include one or more plates of the plurality of electrostatically charged plates.

In one or more embodiments, the controller may be configured to change a voltage one or more electrostatically charged plates such that the electrostatically charged plate changes from attracting the contaminants to repelling the contaminants or from repelling the contaminants to attracting the contaminants.

In one or more embodiments, the controller changes the voltage based on a material provided to the build chamber to form a build piece by a three dimensional (3-D) printer.

In one or more embodiments, methods for removing contaminants are disclosed.

In one or more embodiments, a method for removing contaminants in a three dimension (3-D) printer includes depositing material into a build chamber, generating an energy beam, applying the energy beam to the material, the energy beam generates contaminants in the build chamber when applied to the material, providing an electrostatically charged plate and applying a voltage to the electrostatically charged plate such that the electrostatically charged plate attracts or repels at least a portion of the contaminants in the build chamber.

In one or more embodiments, the method further includes coupling a beam entry window to the build chamber such that the beam entry window is configured to pass the energy beam into the build chamber and positioning the electrostatically charged plate in a configuration to prevent the contaminants from depositing on the beam entry window.

In one or more embodiments, the method further includes providing a first voltage to a first plate of a plurality of electrostatically charged plates.

In one or more embodiments, the method further includes providing a second voltage to a second plate of the plurality of electrostatically charged plates.

In one or more embodiments, the method further includes providing a second voltage to a second plate such that the first voltage is different from or the same as the second voltage.

In one or more embodiments, the method further includes positioning the plurality of electrostatically charged plates on or within one or more walls, including a top wall, of the build chamber and arranging the plurality of electrostatically charged plates in one of an offset configuration, a grid configuration, or a non-parallel configuration. The offset configuration comprises the plurality of electrostatically charged plates not positioned horizontally aligned or not positioned vertically aligned.

In one or more embodiments, the method further includes arranging a first plate and a second plate of the plurality of electrostatically charged plates such that at least one gap is between the first electrostatically charged plate and the second electrostatically charged plate or between any of the electrostatically charged plates.

In one or more embodiments, the method further includes providing a voltage to one or more of the electrostatically charged plates to repel the contaminants away from the beam entry window.

In one or more embodiments, the method further includes providing a voltage to one or more of the electrostatically charged plates to attract the contaminants.

In one or more embodiments, the method of further includes changing the voltage on the electrostatically charged plate such that the electrostatically charged plate changes from attracting the contaminants to repelling the contaminants or from repelling the contaminants to attracting the contaminants.

Other aspects will become readily apparent to those skilled in the art from the following detailed description, wherein is shown and described only several example embodiments by way of illustration. As will be realized by those skilled in the art, concepts described herein are capable of other and different embodiments, and several details are capable of modification in various other respects, all without departing from the present disclosure. Accordingly, the drawings and detailed description are to be regarded as illustrative in nature and not as restrictive.

### BRIEF DESCRIPTION OF THE DRAWINGS

Various aspects of the technology will be presented in the detailed description by way of example, and not by way of limitation, in the appended claims and in the accompanying drawings. In the descriptions that follow, like parts are marked throughout the specification and drawings with the same numerals, respectively. The drawing figures are not necessarily drawn to scale and certain figures can be shown in exaggerated or generalized form in the interest of clarity and conciseness.

FIGS. 1A-1D illustrate respective cross-sectional views of an example Powder Bed Fusion (PBF) system usable with aspects of the disclosure during different stages of operation according to aspects of the disclosure.

FIG. 1E illustrates a functional block diagram of a PBF system in accordance with an aspect of the present disclosure.

FIG. 2 illustrates a cross-sectional view of a PBF system with a build chamber and the build chamber does not include an electrostatically charged plate.

FIG. 3 illustrates a cross-sectional view of a PBF system with one or more electrostatically charged plates in accordance with an aspect of the present disclosure.

FIG. 4 illustrates a cross-sectional view of a PBF system with one or more electrostatically charged plates and optics in accordance with an aspect of the present disclosure.

FIG. 5 illustrates a cross-sectional view of a PBF system with one or more electrostatically charged plates in accordance with an aspect of the present disclosure.

FIG. 6 illustrates a cross-sectional view of a PBF system with one or more electrostatically charged plates in accordance with an aspect of the present disclosure.

FIG. 7 illustrates a cross-sectional view of a PBF system with one or more electrostatically charged plates in accordance with an aspect of the present disclosure.

FIG. 8 illustrates a cross-sectional view of a PBF system with one or more electrostatically charged plates positioned around an outer perimeter of a beam window in accordance with an aspect of the present disclosure.

FIG. 9 illustrates a top view of the electrostatically charged plates positioned around an outer perimeter of the beam window in accordance with an aspect of the present disclosure.

FIG. 10 illustrates a cross-sectional view of a PBF system with film(s) positioned on the beam entry window in accordance with an aspect of the present disclosure.

FIG. 11 illustrates a configuration of the electrostatically charged plates in accordance with an aspect of the present disclosure.

FIG. 12 illustrates a configuration of the electrostatically charged plates in accordance with an aspect of the present disclosure.

FIG. 13 illustrates a configuration of the electrostatically charged plates in accordance with an aspect of the present disclosure.

FIG. 14 illustrates a configuration of the electrostatically charged plates in accordance with an aspect of the present disclosure.

FIG. 15 illustrates a configuration of the electrostatically charged plates in accordance with an aspect of the present disclosure.

FIG. 16 illustrates a configuration of the electrostatically charged plates in accordance with an aspect of the present disclosure.

FIG. 17 illustrates a flow diagram showing an example method in accordance with an aspect of the present disclosure.

### DETAILED DESCRIPTION

This disclosure describes a series of electrostatically charged plates such as metal plates that are a part of one or more of the build chamber walls of a powder bed fusion (PBF) 3D printer and system. Because these plates are charged electrostatically, they will attract byproducts such as soot particles that flow near them. The byproducts including soot particles are a problem for the manufacturing process of a build piece within a powder bed fusion (PBF) 3D printer and system because the byproducts contaminate the optics and optical system which causes process instability. The byproducts including the soot can also find its way into the build piece by landing on the build piece before a next layer of material to be fused/melted is exposed to an energy beam which causes defects within the material of the build piece. The gas flow systems in laser powder bed fusions systems are designed to remove a large percentage of the byproducts including the soot particles but even the best gas flow systems cannot remove one hundred percent of the byproducts and soot that is generated.

To overcome the above problems associated with byproducts in a build chamber causing defects of the build piece and damaging components of a PBF system, the disclosure provides a method and an apparatus from removing byproducts within a build chamber. The disclosed methods and apparatuses within the various example embodiments prevent byproducts from creating defects within the build piece and prevent the byproducts from damaging components of a PBF system by associating one or more electrostatically charged plates with a build chamber. The one or more electrostatically charged plates may be placed within or on the build chamber, e.g., chamber walls. In some embodiments, the one or more electrostatically charged plates may be place in a gas flow system, e.g., vents, pipes, gas pathways of a PBF system.

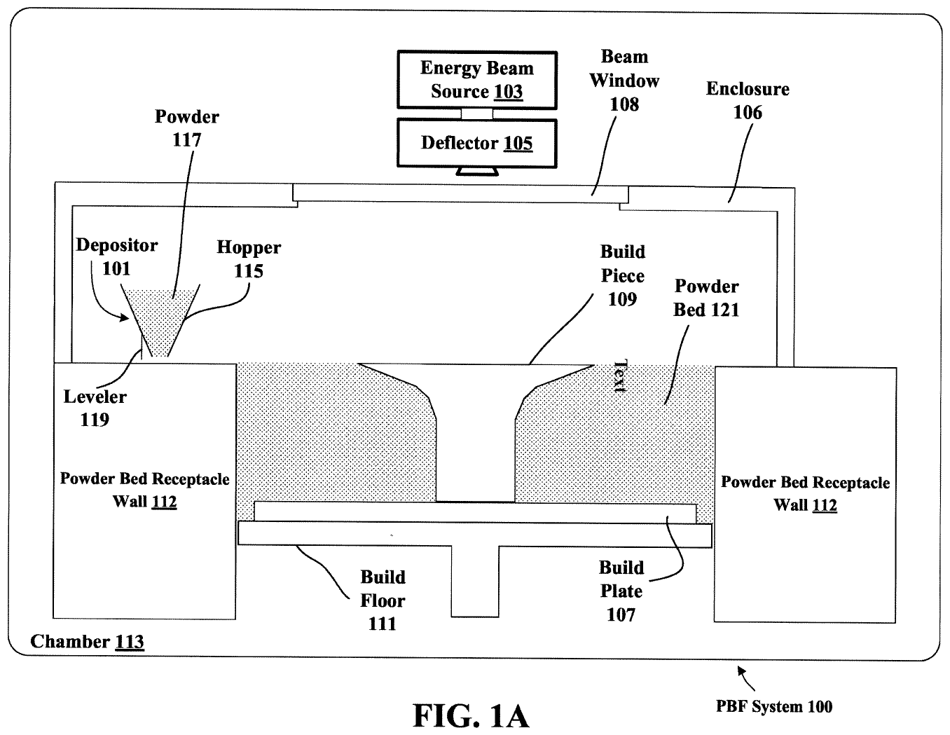

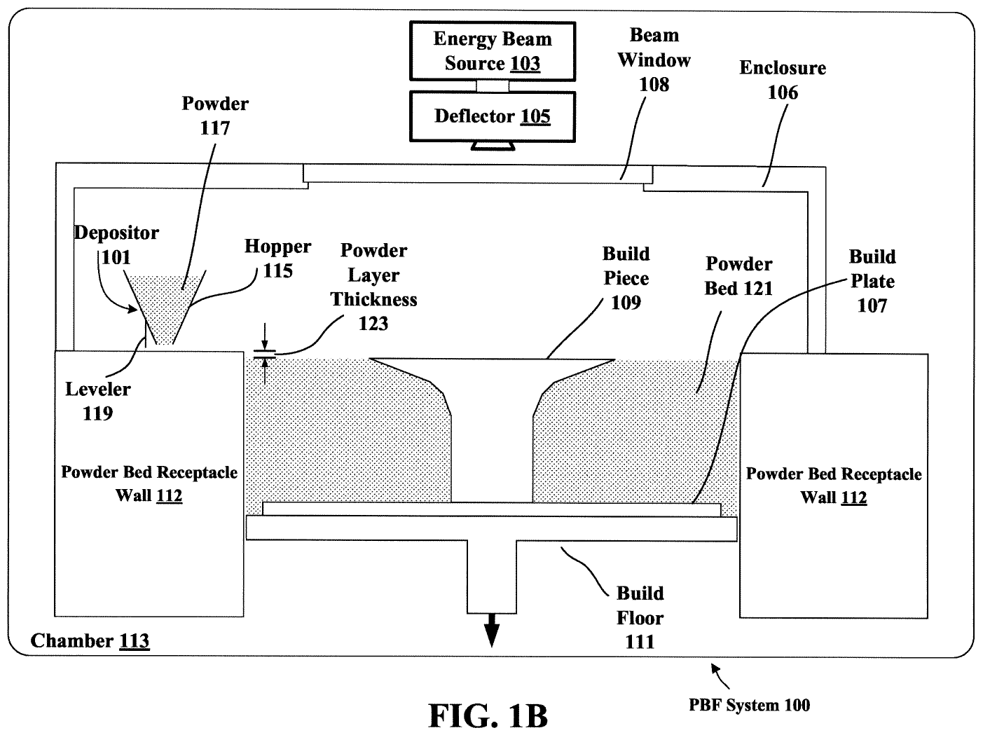

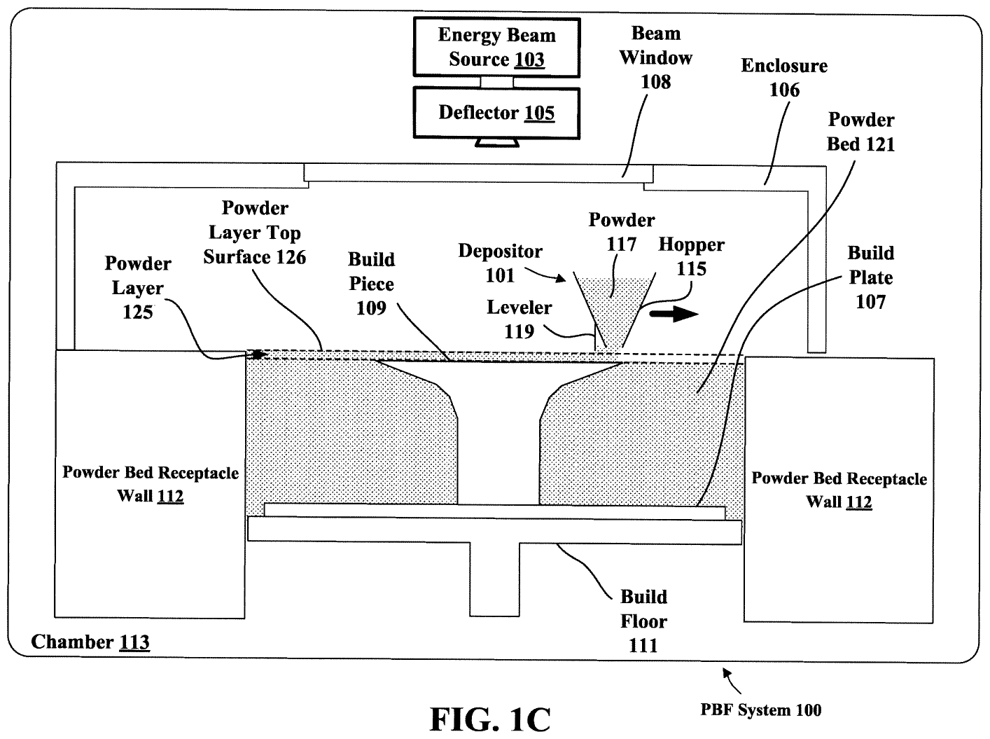

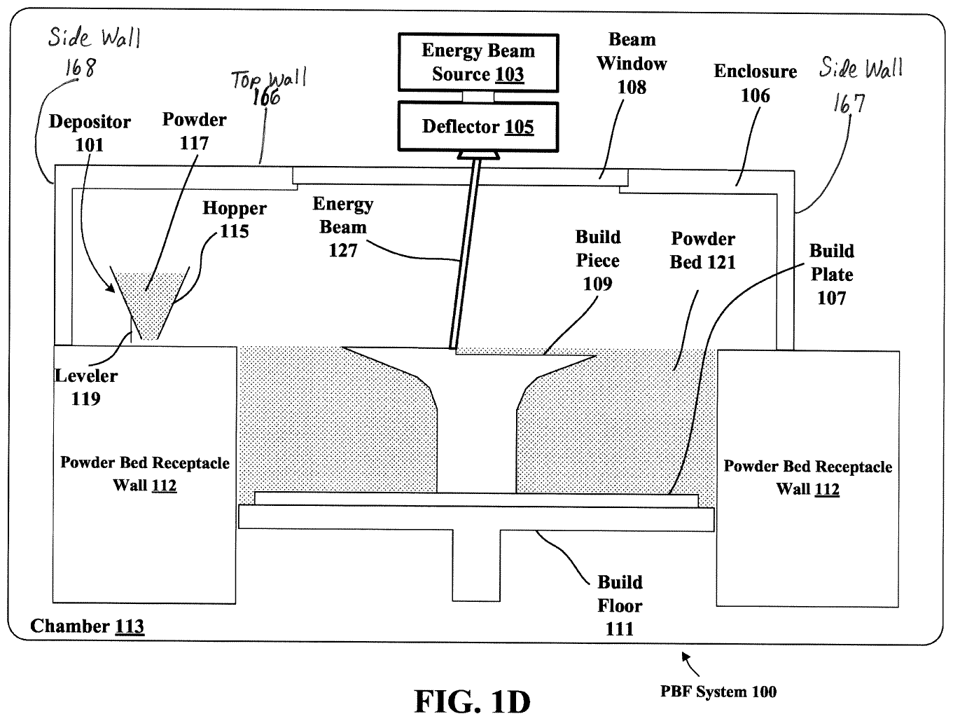

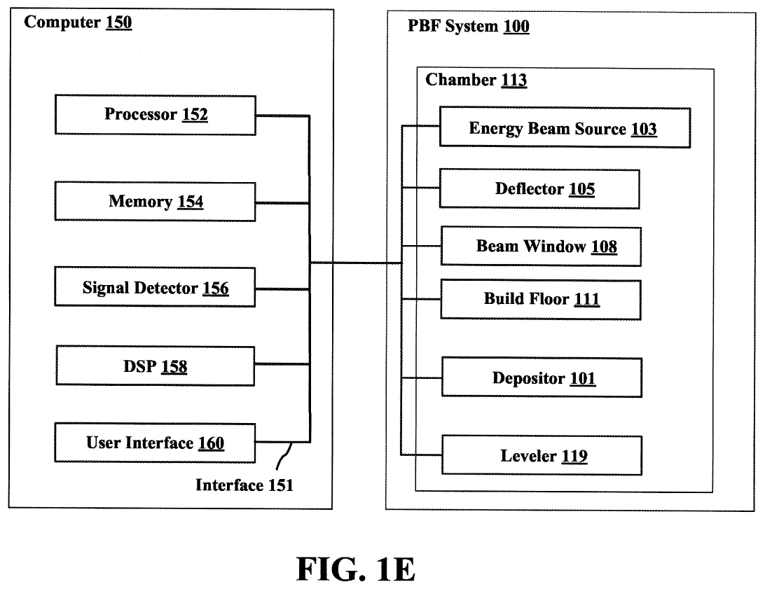

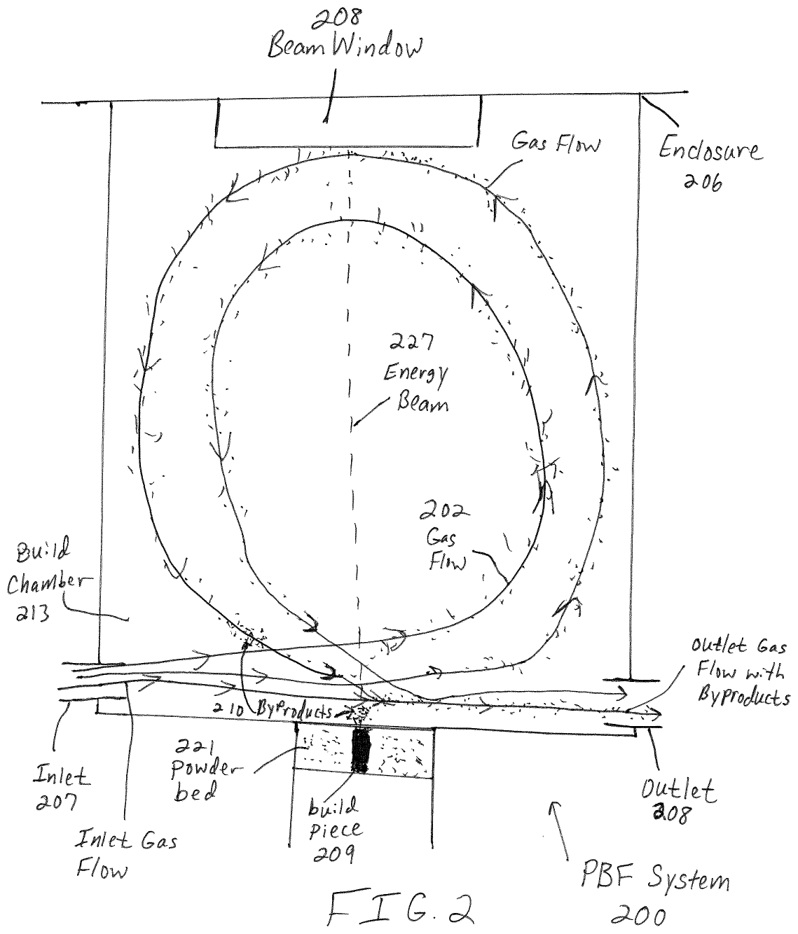

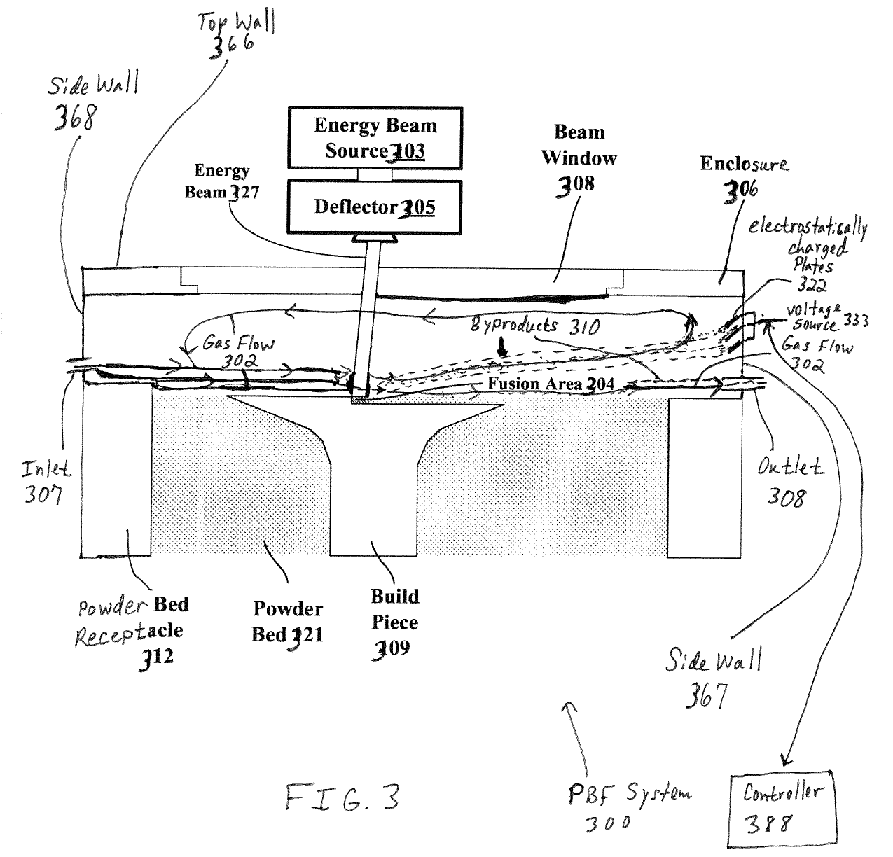

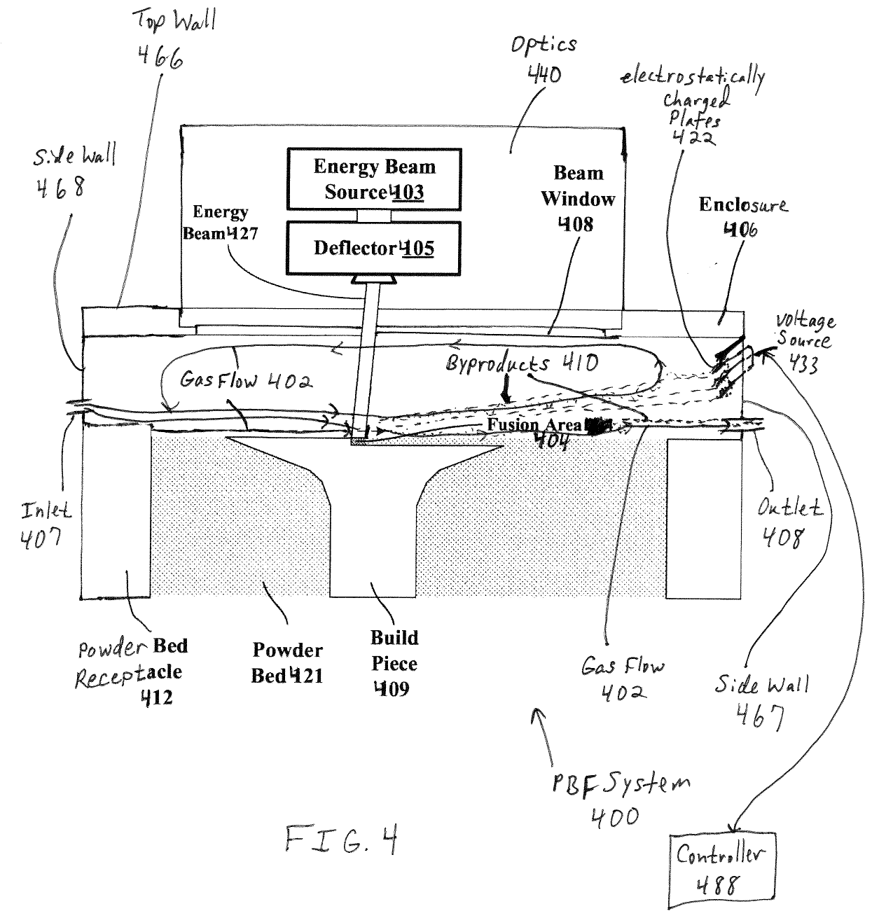

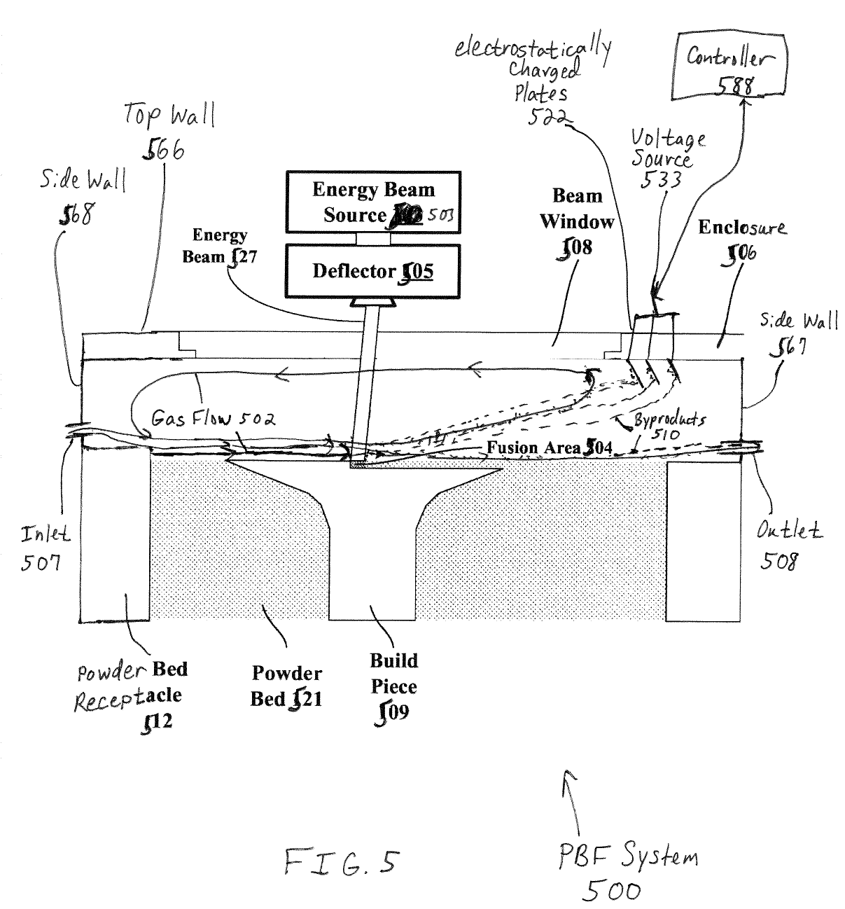

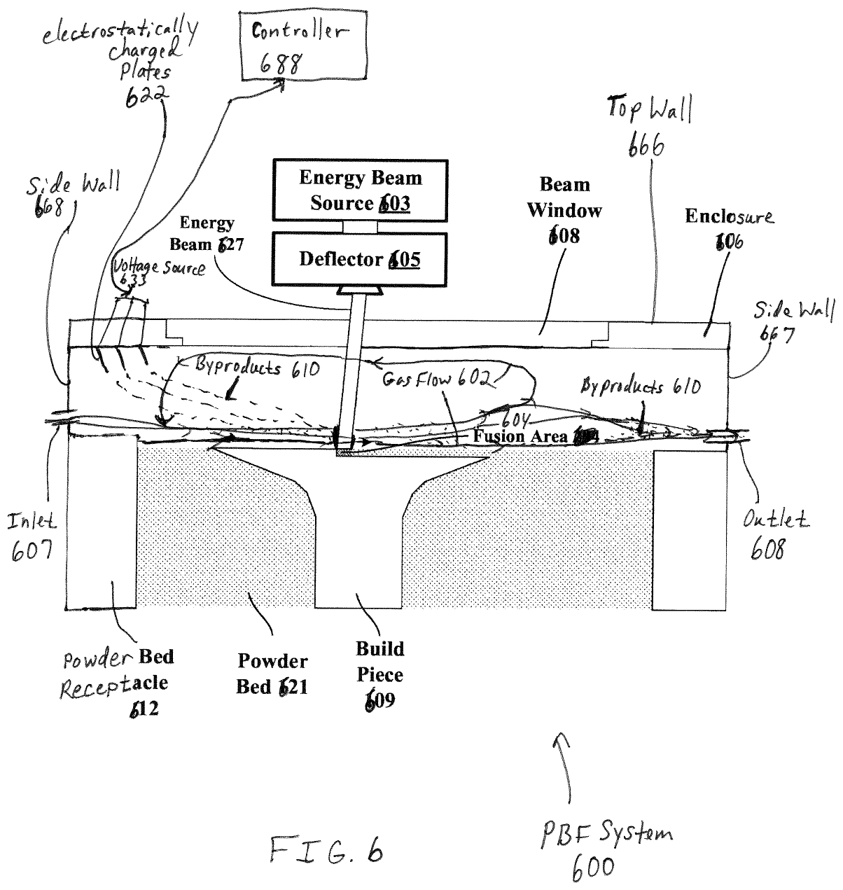

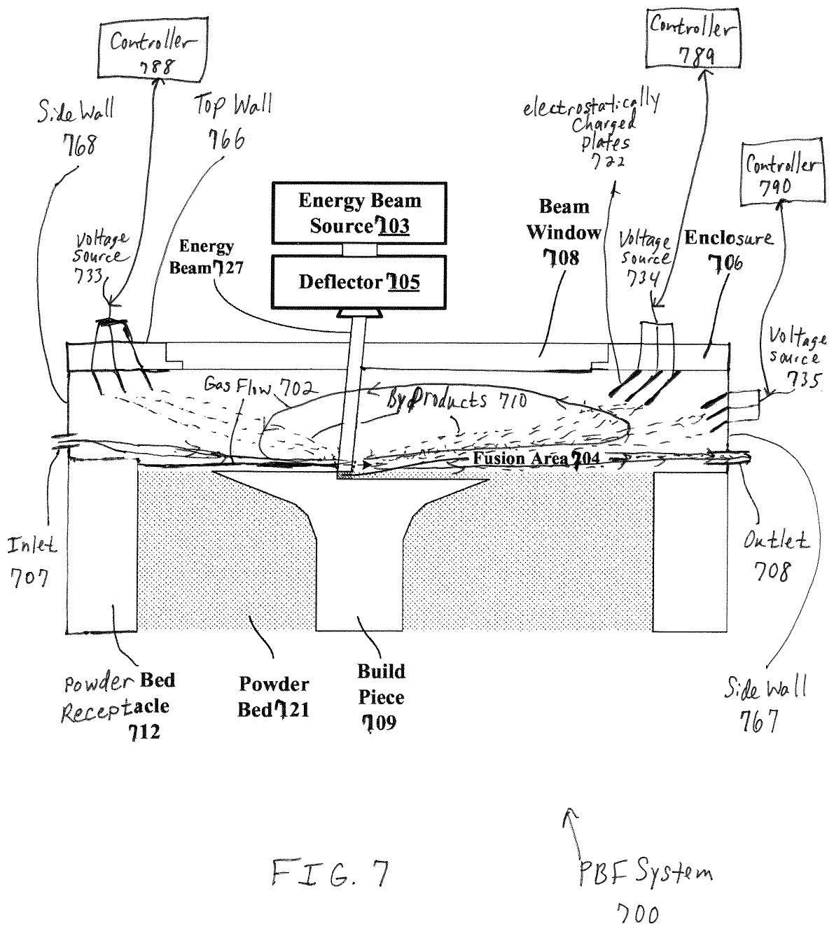

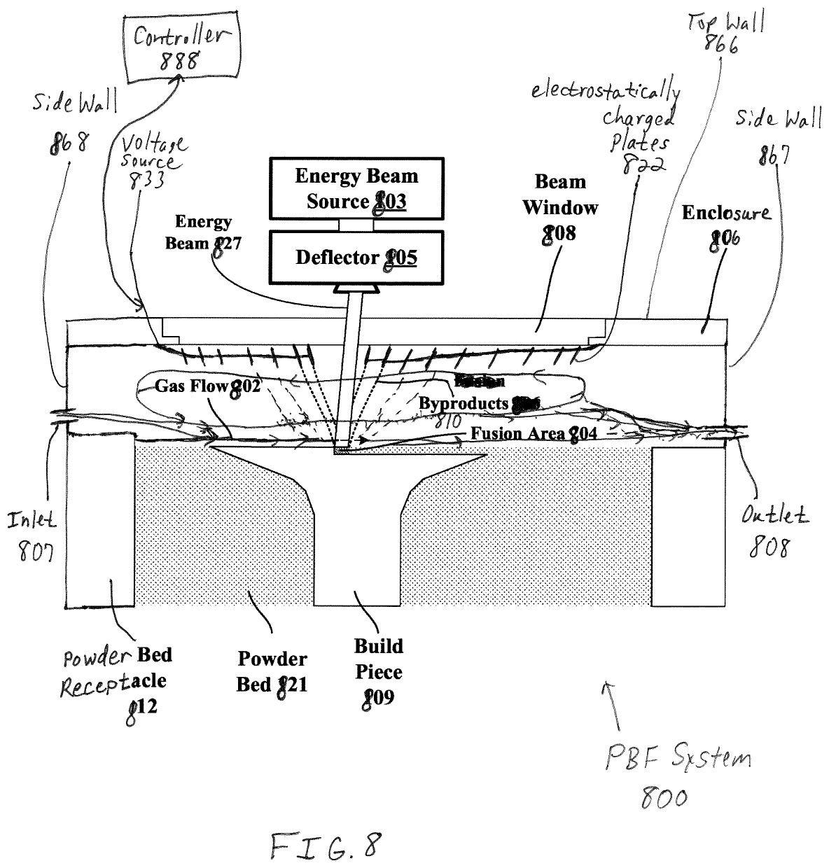

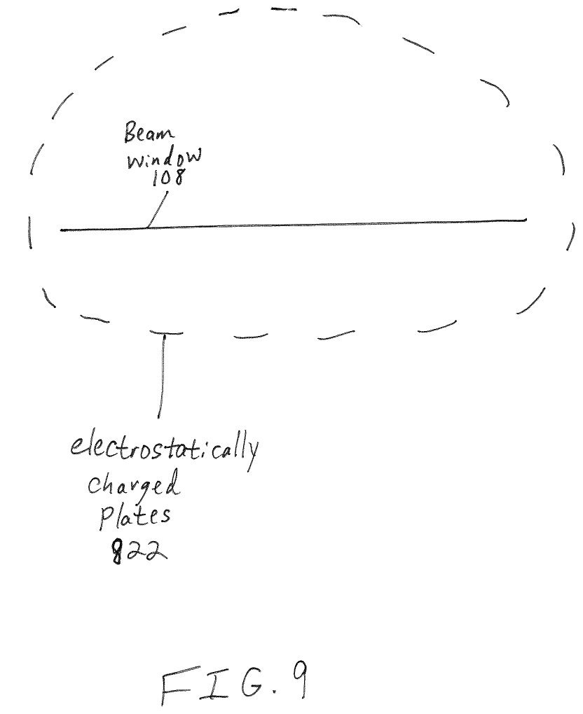

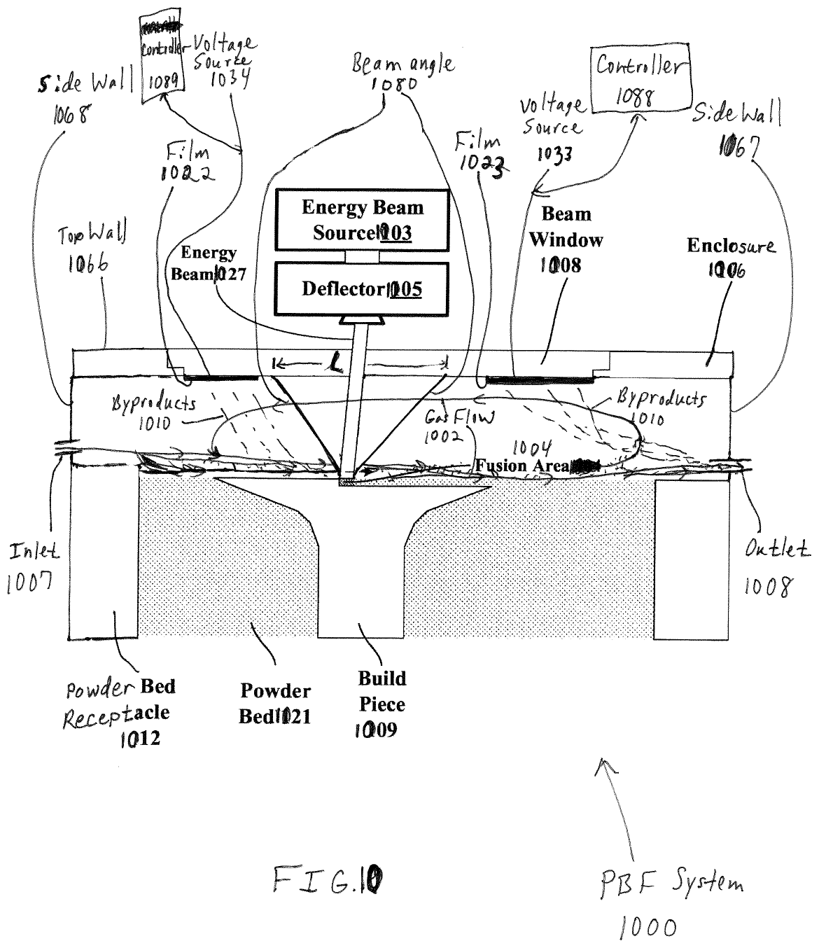

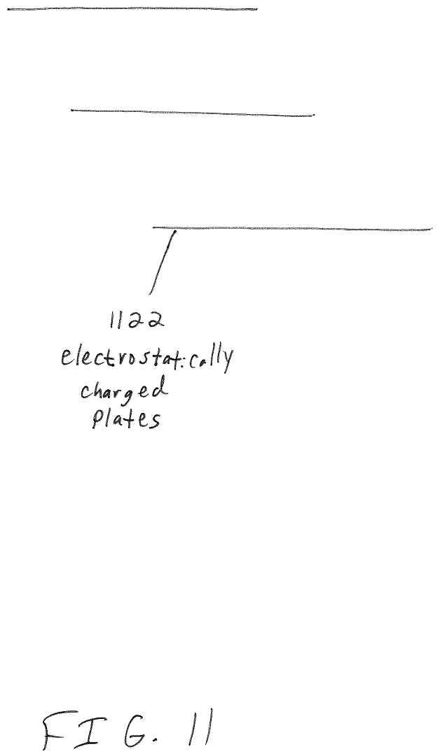

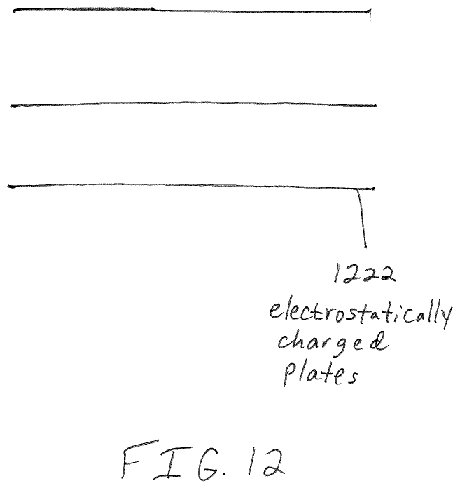

FIGS. 1A-1D illustrate respective side views of an example of a PBF system 100 usable with aspects of the disclosure including a 3-D printer during different stages of operation. As noted above, the particular embodiment illustrated in FIGS. 1A-1D is one of many suitable examples of a PBF system employing principles of this disclosure. It should also be noted that elements of FIGS. 1A-1D and the other figures in this disclosure are simplified and not necessarily drawn to scale, but may be drawn larger or smaller and/or with reduced detail for the purpose of better illustration of concepts described herein. PBF system 100 can include enclosure 106, depositor 101 that can deposit each powder layer 125, energy beam source 103 that can generate energy beam 127, deflector 105 that can direct or redirect the energy beam to melt powder 117, and build plate 107 that can support one or more build pieces, such as build piece 109. PBF system 100 can also include build floor 111 positioned within a powder bed receptacle and between powder bed receptacle walls 112. Build floor 111 can progressively lower build plate 107 so that depositor 101 can deposit a next layer. In some examples, all of the above disclosed features of the PBF system may reside in chamber 113 to enclose these features, thereby protecting these features from atmospheric conditions (e.g., providing the features in an inert environment) and temperature regulation and mitigating contamination risks. Depositor 101 can include hopper 115 that contains powder 117, such as a metal (e.g., alloy) or non-metal (e.g., plastic or thermoplastic polymer) powder, and leveler 119 that can level the top of each layer of deposited powder.

Referring specifically to FIG. 1A, this figure shows PBF system 100 after a slice of build piece 109 has been fused by energy beam 127, but before the next layer of powder has been deposited. In fact, FIG. 1A illustrates a time at which PBF system 100 has already deposited and fused a partially completed build piece in multiple layers to form the current state of build piece 109. The multiple layers already deposited have created powder bed 121, which includes powder that was deposited but not melted.

FIG. 1B shows PBF system 100 at a stage in which build floor 111 can lower by powder layer thickness 123. The lowering of build floor 111 causes build piece 109 and powder bed 121 to drop by powder layer thickness 123, so that the top of the build piece and powder bed are lower than the top of powder bed receptacle wall 112 by an amount equal to the powder layer thickness. In this way, for example, a space with a consistent thickness equal to powder layer thickness 123 can be created over the tops of build piece 109 and powder bed 121.

FIG. 1C shows PBF system 100 at a stage in which depositor 101 is positioned to deposit powder 117 in a space created over the top surfaces of build piece 109 and powder bed 121 and bounded by powder bed receptacle walls 112. In this example, depositor 101 moves over the defined space while releasing powder 117 from hopper 115. Leveler 119 can level the released powder to form powder layer 125 that has a thickness substantially equal to powder layer thickness 123 (see FIG. 1B). Thus, the powder in a PBF system can be supported by a powder material support structure, which can include, for example, build plate 107, build floor 111, build piece 109, walls 112, and the like. It should be noted that the illustrated thickness of powder layer 125 (i.e., powder layer thickness 123 (FIG. 1B)) is greater than an actual thickness used for the example involving 150 previously-deposited layers discussed above with reference to FIG. 1A.

FIG. 1D shows PBF system 100 at a stage in which, following the deposition of powder layer 125 (FIG. 1C), energy beam source 103 generates energy beam 127 and deflector 105 applies the energy beam to melt the next slice (i.e., powder in the powder layer) in build piece 109. In various example embodiments, energy beam source 103 can be an electron beam source, in which case energy beam 127 constitutes an electron beam. Deflector 105 can include deflection plates that can generate an electric field or a magnetic field that selectively deflects the electron beam to cause the electron beam to scan across areas designated to be melted. In various embodiments, energy beam source 103 can be a laser beam source, in which case energy beam 127 is a laser beam. Deflector 105 may include an optical system that uses reflection and/or refraction to manipulate the laser beam to scan selected areas/regions on the powder layer to be melted. In various embodiments, the deflector 105 can include one or more gimbals and actuators that can rotate and/or translate the energy beam source to position the energy beam. In various embodiments, energy beam source 103 and/or deflector 105 can modulate the energy beam, e.g., turn the energy beam on and off as the deflector scans so that the energy beam is applied only in the appropriate areas/regions of the powder layer. For example, in various aspects of the disclosure, the energy beam can be modulated by a digital signal processor (DSP). The deflector may include any known system in the art, for example a galvo-scanner or galvanometer, and/or a raster scanner. It is noted that while a single energy beam source 103 and/or deflector 105 is shown, aspects of the disclosure are usable with and may include a system with multiple energy sources and/or deflectors.

As shown in FIG. 1D, PBF system 100 is at a stage in which, following the deposition of powder layer 125 (FIG. 1C), energy beam source 103 generates an energy beam 127 and deflector 105 applies the energy beam to fuse the next slice in build piece 109. In various example embodiments, energy beam source 103 can be an electron beam source, in which case energy beam 127 constitutes an electron beam. Deflector 105 can include deflection plates that can generate an electric field or a magnetic field that selectively deflects the electron beam to cause the electron beam to scan across areas designated to be fused. In various embodiments, energy beam source 103 can be a laser, in which case energy beam 127 is a laser beam. When the energy beam source is a laser, the PBF system or printer is referred to as a laser powder-bed fusion (L-PBF) system or printer. Deflector 105 can include an optical system that uses reflection and/or refraction to manipulate the laser beam to scan selected areas to be fused.

FIG. 1E illustrates a functional block diagram in accordance with an aspect of the present disclosure and useable with disclosed 3-D printer, and PBF systems and apparatuses. In an aspect of the present disclosure, control devices and/or elements, including computer software, may be coupled to PBF system 100 to control one or more components or process parameters within PBF system 100. Such a device may be a computer 150, which may include one or more process parameters that may assist in the control of PBF system 100. Computer 150 may communicate with PBF system 100, and/or other AM systems, via one or more interfaces 151 (e.g., a bus system). Computer 150 and/or interface 151 and/or one or more controllers are examples of devices that may be configured to implement the various systems, apparatuses and methods described herein, that may assist in controlling PBF system 100 and/or other AM systems. Interface 151 may comprise an input/output device that allows computer 150 to exchange information with other devices. In some implementations, interface 151 may include one or more of a parallel port, a serial port, or other computer interfaces.

In an aspect of the present disclosure, computer 150 may include at least one processor 152, memory 154, signal detector 156, digital signal processor (DSP) 158, and one or more user interfaces 160. Computer 150 may include additional components without departing from the scope of the present disclosure.

Computer 150 may include at least one processor 152, which may assist in the control, processing and/or operation of PBF system 100. The processor 152 may also be referred to as a central processing unit (CPU). Memory 154, which may include both read-only memory (ROM) and random-access memory (RAM), may provide instructions and/or data to processor 152. A portion of memory 154 may also include non-volatile random-access memory (NVRAM). Processor 152 typically performs logical and arithmetic operations based on program instructions stored within memory 154. The instructions in memory 154 may be executable (e.g., by processor 152) to implement the functions and methods described herein.

Processor 152 may include or be a component of a processing system implemented with one or more processors. The one or more processors may be implemented with any combination of general-purpose microprocessors, microcontrollers, digital signal processors (DSPs), floating point gate arrays (FPGAs), programmable logic devices (PLDs), controllers, state machines, gated logic, discrete hardware components, dedicated hardware finite state machines, or any other suitable entities or components that can perform calculations or other manipulations of information.

Processor 152 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, RS-274 instructions (G-code), numerical control (NC) programming language, and/or any other suitable format of code). The instructions, when executed by the one or more processors, cause the processing system to perform the various functions described herein.

Computer 150 may also include signal detector 156 that may be used to detect and quantify any level of signals received by computer 150 for use by processor 152 and/or other components of computer 150. Signal detector 156 may detect such signals of energy beam source 103 power, deflector 105 position, beam window 108 characteristics, build floor 111 height, amount of powder 117 remaining in depositor 101, leveler 119 position, and other signals. Signal detector 156, in addition to or instead of processor 152 may also control other components as described with respect to the present disclosure. Computer 150 may also include DSP 158 for use in processing signals received by computer 150 or processor 162. The DSP may be configured to generate instructions and/or packets of instructions for transmission to PBF system 100.

Computer 150 may further comprise user interface 160 in some aspects. User interface 160 may comprise a keypad, a pointing device, and/or a display. User interface 160 may include any element or component that conveys information to a user of computer 150 and/or receives input from the user.

The various components of computer 150 may be coupled together by bus system 151. Bus system 151 may include a data bus, for example, as well as a power bus, a control signal bus, and a status signal bus in addition to the data bus. Components of computer 150 may be coupled together or accept or provide inputs to each other using some other mechanism.

Although a number of separate components are illustrated in FIG. 1E, one or more of the components may be combined or commonly implemented. For example, processor 152 may be used to implement not only the functionality described above with respect to processor 152, but also to implement the functionality described above with respect to signal detector 156, DSP 158, and/or user interface 160. Further, each of the components illustrated in FIG. 1E may be implemented using a plurality of separate elements.

By way of example, an element, or any portion of an element, or any combination of elements may be implemented using one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors may execute software.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by computer 150. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by computer 150. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium comprises a non-transitory computer readable medium (e.g., tangible media). The RAM may include one or more Static Random Access Memory (SRAM), Dynamic Random Access Memory (DRAM), Synchronous Dynamic Random Access Memory (SDRAM), Double Data-Rate Random Access Memory (DDR SDRAM), or other suitable volatile memory. The Read-only Memory (ROM) may include one or more Programmable Read-only Memory (PROM), Erasable Programmable Read-only Memory (EPROM), Electronically Erasable Programmable Read-only memory (EEPROM), flash memory, or other types of non-volatile memory.

As described with respect to FIGS. 1A-ID, PBF system 100 may include beam window 108. Enclosure 106 and beam window 108 may provide a protective structure within PBF system 100, to allow for fusing of the powder bed in a controlled environment. The controlled environment may provide a non-oxidizing gas or inert gas, e.g., nitrogen, argon, etc., within enclosure 106 to allow for fusing of powder bed 121 without creation of metal oxides. Metal oxides formed within build piece 109 during fusing may reduce the overall strength of build piece 109 or create weak spots within build piece 109.

Throughout the disclosure, a three-dimension (3-D) printer may be any of the disclosed PBF systems or may include less components than any of the disclosed PBF systems.

FIG. 2 illustrates PBF system 200 without an electrostatically charged plate and may include the above disclosed components of PBF system 100 illustrated in FIGS. 1A-1E. Energy beam 227 is applied through beam window 208 by a deflector (not shown) and onto material such as powder in powder bed 221 in order to fuse/melt the powder in the powder bed forming build piece 209. The energy beam applied to the material creates byproducts 210 within enclosure 206 as the powder in the powder bed is being fused. Thus, gas flows 202 into build chamber 213 via inlet 207 in order to remove the byproducts from the build chamber via outlet 208 during the formation of the build piece. The build piece is formed by the energy beam fusing/melting the material within the powder bed. Some of the byproducts along with the gas flow exit the outlet. However, not all of the unwanted byproducts will be removed from the build chamber by exiting the outlet. As illustrated in FIG. 2, some of the gas that enters the inlet may flow in a circulating configuration such that the gas flow moves at least some of the byproducts upward toward the beam window and thus some of the byproducts may attach to the beam window. The byproducts attaching to the beam window may cause defects to the beam window and to the process of fusing/melting of the powder by the energy beam. In various disclosed embodiments one or more electrostatically charged plates may be associated with walls of an enclosure to, for example, protect components of the PBR system.

FIG. 3 illustrates an example embodiment of PBR system 300. PBR system 300 may include the components of PBR system 100 illustrated in FIGS. 1A-1E and 4-8. PBR system 300 includes enclosure 306, and the enclosure includes top wall 366 and sides walls (e.g., 367,368 and unshown front and back side walls). One or more of the side walls may include one or more gas inlets 307 and may include one or more gas outlets 308.

PBR system 300 includes energy beam source 303, which generates energy beam 327. Energy beam source 303 and/or the deflector 305 can modulate the energy beam, e.g., turn the energy beam on and off as the deflector scans so that the energy beam is applied only in the appropriate areas of a material (e.g., metal powder) of a powder layer within powder bed 321. For example, in various embodiments, the energy beam can be modulated by using signals generated by a digital signal processor (DSP) or other similar signal generating devices or components. The energy beam is applied through beam window 308 by deflector 305 and onto the material in the powder bed in order to fuse/melt the material in the powder bed forming build piece 309. The energy beam applied to the material creates byproducts 310 as the material in the powder bed is being fused in fusion area 304. Fusion of the material in the powder bed may also generate byproducts 310 in other areas of build piece 309 as those areas of build piece 309 cool down after fusion. One or more electrostatically charged plates 322 may be associated with one or more sides walls (e.g., 367,368) and/or top wall 366. In this way, for example, byproducts 310 may be attracted to and collected on the surface(s) of the electrostatically charged plates and/or may repel the byproducts away from a component or components of the PBR system. The repelled byproducts may then be attracted to surfaces of other electrostatically charged plates and/or exit through the one or more gas outlets. More than one energy beam source, more than one deflector and more than one beam window may be included in the PBR system. For example, two or more energy beam sources 303, two or more deflectors 305 and two or more beam windows 308 may be included in the PBR system such that each energy beam source generates an energy beam and each deflector enables each energy beam to be directed through a corresponding beam window of the plurality of windows. In a specific example, a first energy beam source generates a first energy beam and a first deflector enables the first energy beam to be directed through a first beam window and a second energy beam source generates a second energy beam and a second deflector enables the second energy beam to be directed through a second beam window.

A gas source (not shown) supplies a gas such that the gas enters through the one or more gas inlets 307 and exits through the one or more gas outlets 308. The gas provides a gas flow 302 within the build chamber to remove a percentage of the byproducts from the build chamber but as stated above, not all of the byproducts generated by the fusion of the powder are removed from the build chamber by only the gas flow. The gas may be a non-oxidizing gas or an inert gas such as nitrogen, argon, helium, neon, xenon, radon or krypton.

One or more electrostatically charged plates 322 may be arranged in various configurations, e.g., attached to one or more of the side walls and/or the top wall. For example, FIG. 3 illustrates a plurality electrostatically charged plates 322 attached to side wall 367. In various embodiments, a single electrostatically charged plate 322 may be attached to side wall 367. The one or more electrostatically charged plates are positioned in various configurations on or within the one or more side walls and/or the top wall such that the gas flow including the byproducts attach to the surface(s) of the electrostatically charged plates when a voltage is applied to each of the one or more electrostatically charged plates and/or repel byproducts 310 away from the one or more electrostatically charged plates such that the byproducts exit the one or more outlets without attaching or contacting any beam window 308. Controller 388 is coupled and/or in communication (i.e., wired or wirelessly) with voltage source 333 such that the controller allows voltage from voltage source 333 to be applied to the one or more electrostatically charged plates in order to attract or repel at least a portion of the byproducts in the build chamber. For example, if the material being fused/melted is metallic or an alloy, then some of the byproducts will be metallic and when applying an appropriate voltage (changing the plate(s) with an opposite charge of the byproducts) is applied to the electrostatically charged plate(s), the metallic byproducts will be attracted to and collect onto the surface(s) of the electrostatically charged plate(s), thus removing the byproducts from the gas flow. In another example, the one or more electrostatically charged plates have an appropriate voltage (changing the plate(s) with the same charge of the byproducts) applied to the plate(s), the metallic byproducts will be repelled away from the electrostatically charged plate(s). For example, having one or more electrostatically charged plates positioned adjacent beam window 308 and applying an appropriate voltage (changing the plate(s) with the same charge of the byproducts) to the plate(s), the metallic byproducts will be repelled away from the beam window by the electrostatically charged plate(s). Because one or more of the electrostatically charged plate has attracted and/or repelled the byproducts, the portion of the gas flow circulating in an upward direction toward an upper part of the enclosure and/or adjacent the beam window is free or substantially free of the byproducts. As illustrated in FIG. 3, the one or more electrostatically charged plates are positioned on side wall 367 and a voltage is applied, via voltage source 333, to each of the electrostatically charged plates such that the byproducts are attracted to the electrostatically charged plates and the byproducts attach to the surface(s) of the electrostatically charged plates, thus preventing the byproducts from attaching to the beam window and to the material, which is to be fused by the energy beam. In this way, for example, the beam window and the build piece may be kept free or substantially free from byproduct contamination.

In various embodiments, the controller may be configured to provide an individual voltage to each of the plurality of electrostatically charged plates. For example, the controller provides the voltage from the voltage source to be apply a first voltage to/on a first plate of the plurality of electrostatically charged plates and apply a second voltage to/on a second plate of the plurality of electrostatically charged plates. The first voltage may be the same or different from the second voltage. The controller may be configured to provide a voltage to any of the electrostatically charged plates such that byproducts are repelled away and/or attracted to any one of the electrostatically charged plates. Additionally and/or alternatively, the controller may be configured to change a voltage on the electrostatically charged plate such that the electrostatically charged plate changes from attracting the contaminants to repelling the contaminants or from repelling the contaminants to attracting the contaminants. The controller may be configured to change the voltage based on a material provided to the build chamber to form a build piece by a three dimensional (3-D) printer.

In various embodiments, the one or more electrostatically charged plates may be positioned in various configurations and locations relative to the chamber and the side and top walls. For example, one or more electrostatically charged plates 322 may be placed before (e.g., to the left of a beam window as shown in FIGS. 6 and 7) a beam window and/or after (e.g., to the right of a beam window as shown in FIGS. 3-5 and 7) a beam window. The number of electrostatically charged plates before a beam window may be the same, more or less than the number of electrostatically charged plates after a beam window. The number of electrostatically charged plates 322 on a side wall may be the same, more or less than the number of electrostatically charged plates 322 on the top wall.

The side walls are the walls on the sides of the geometrically shaped enclosure 106. For example, the side walls include the four walls of a square or rectangular shaped enclosure 306. Top wall 366 may include one or more beam windows 308. In various embodiments, the top wall may include optics (See FIG. 4) and one or more beam windows 308. Side wall 367 may include gas inlet 307 and side wall 368 may include gas outlet 308. The gas inlet may be in a lower or upper portion of the side wall and the gas outlet may be in a lower portion or an upper portion of the same or different side wall. In various embodiments, side wall 367 may include a plurality of gas inlets 307 and side wall 368 may include a plurality of gas outlets 308 or side wall 368 may include a plurality of gas inlets 307 and side wall 367 may include a plurality of gas outlets 308. A gas inlet (e.g., a first gas inlet) may be in a lower portion of the side wall and another gas inlet (e.g., a second gas inlet) may be in an upper portion of the same or different side wall. A gas outlet (e.g., a first gas outlet) may be in a lower portion of the side wall and another gas outlet (e.g., a second gas outlet) may be in an upper portion of the same or different side wall.

In various embodiments, one electrostatically charged plate may be attached to one or more side walls, or one electrostatically charged plate may be attached to the top wall, or one electrostatically charged plate may be attached to one or more of the side walls and one electrostatically charged plate may be attached to the top wall.

In various embodiments, one or more electrostatically charged plates may be integral (i.e., form a unitary/one piece structure) with the one or more side walls and/or the top wall.

In various embodiments, the electrostatically charged plates may include triangle, square, or rectangle shapes or any other geometric shape. In addition and/or alternatively, the electrostatically charged plates shapes may include planer, non-planer, linear, non-linear, curved, round, oval or wave shaped. The electrostatically charged plate shapes may additionally and/or alternatively include undulations and/or surface features such as fins, grooves, protrusions, perforations (e.g., mesh), and/or indentations. Two or more electrostatically charged plates may have the same shape or may have different shapes. Two or more electrostatically charged plates may have the same or different undulations and/or surface features. Two or more electrostatically charged plates may have the same or different lengths, widths and diameters. Two or more electrostatically charged plates may have the same or different distances therebetween. Two or more electrostatically charged plates may be made from the same or different material. Two or more electrostatically charged plates may have the same or different angles therebetween. For example, a first and a second electrostatically charged plate may have a first angle between the surfaces of the first and second electrostatically charged plates and a third and fourth electrostatically charged plate may have a second angle between the surfaces of the third and fourth electrostatically charged plates. The first angle may be the same as or different from the second angle. The electrostatically charged plates may include a metallic material and/or other electrically-conductive material. The metallic material may include aluminum, an alloy or any known metal. The electrostatically charged plates may be 3-D printed using L-PPBF.

In various embodiments, the configuration of the one or more electrostatically charged plates positioned on or integral with the one or more side walls and/or the top wall may be oriented perpendicular to the surface of the top and/or side walls or oriented at an angle other than ninety degrees to the surface of the top and/or side walls. For example, the one or more electrostatically charged plates may be angled with respect to the surface of the side wall(s) and/or the top wall such that the one or more electrostatically charged plates maximize the attraction or repulsion of at least a portion of the byproducts within the build chamber. In various embodiments, the one or more electrostatically charged plates include any configuration, as well as any of the configurations illustrated in FIGS. 11-16. For example, the plates on a side wall may have one or more of the configurations illustrated in FIGS. 11-16, another side wall may have one or more of the configurations illustrated in FIGS. 11-16 and the top wall may have one or more of the configurations illustrated in FIGS. 11-16.

In various embodiments, the voltage source may be a battery, an AC source, facility power, a generator, or any apparatus generating a voltage. The voltage source may include one or more wires extending through the top wall and/or one or more side walls and each wire couples to a plate of the electrostatically charged plates.

In various embodiments, the gas source may include a gas supply system, a gas bottle supply or any gas supply apparatus known in the art of supplying gas.

FIG. 4 illustrates an example embodiment of PBR system 400. PBR system 400 may include the components of PBR systems illustrated in FIGS. 1A-1E, 3 and 5-8. PBR system 400 includes optics 440. The optics may include energy beam source 403, deflector 405, one or more gimbals, galvanometer, mirrors, lenses and actuators such that the energy beam source can rotate and/or translate to position energy beam 427, which is generated by the energy beam source. The optics may be coupled to enclosure 406. One or more beam windows 408 may be coupled to the optics. Each beam window may be coupled to the enclosure. In various embodiments, the energy beam source and/or the deflector can modulate energy beam 427, e.g., turn the energy beam on and off as the deflector scans so that the energy beam is applied only in the appropriate areas of the powder layer. For example, in various embodiments, the energy beam can be modulated by using signals generated by a digital signal processor (DSP) or other similar signal generating devices or components.

PBR system 400 includes enclosure 406, and the enclosure includes top wall 466 and sides walls (e.g., 467,468 and unshown front and back side walls). One or more of the side walls may include one or more gas inlets 407 and may include one or more gas outlets 408.

The energy beam is applied through beam window 408 by deflector 405 and onto the material in the powder bed in order to fuse/melt the material in the powder bed forming build piece 409. The energy beam applied to the material creates byproducts 410 as the material in the powder bed is being fused in fusion area 404. Fusion of the material in the powder bed may also generate byproducts 410 in other areas of build piece 409 as those areas of build piece 409 cool down after fusion. One or more electrostatically charged plates 422 may be associated with one or more sides walls (e.g., 467,468) and/or top wall 466. In this way, for example, byproducts 410 may be attracted to and collected on the surface(s) of the electrostatically charged plates and/or may repel the byproducts away from a component or components of the PBR system. The repelled byproducts may then be attracted to surfaces of other electrostatically charged plates and/or exit through the one or more gas outlets.

A gas source (not shown) supplies a gas such that the gas enters through the one or more gas inlets 407 and exits through the one or more gas outlets 408. The gas provides a gas flow 402 within the build chamber to remove a percentage of the byproducts from the build chamber but as stated above, not all of the byproducts generated by the fusion of the powder are removed from the build chamber by only the gas flow. The gas may be a non-oxidizing gas or an inert gas such as nitrogen, argon, helium, neon, xenon, radon or krypton.

One or more electrostatically charged plates 422 may be arranged in various configurations, e.g., attached to one or more of the side walls and/or the top wall. For example, FIG. 4 illustrates a plurality electrostatically charged plates 422 attached to side wall 467. In various embodiments, a single electrostatically charged plate 422 may be attached to side wall 467. The one or more electrostatically charged plates are positioned in various configurations on or within the one or more side walls and/or the top wall such that the gas flow including the byproducts attach to the surface(s) of the electrostatically charged plates when a voltage is applied to each of the one or more electrostatically charged plates and/or repel byproducts 410 away from the one or more electrostatically charged plates such that the byproducts exit the one or more outlets without attaching or contacting any beam window 408. Controller 488 is coupled and/or in communication (i.e., wired or wirelessly) with voltage source 433 such that the controller allows voltage from voltage source 433 to be applied to the one or more electrostatically charged plates in order to attract or repel at least a portion of the byproducts in the build chamber. For example, if the material being fused/melted is metallic or an alloy, then some of the byproducts will be metallic and when applying an appropriate voltage (changing the plate(s) with an opposite charge of the byproducts) is applied to the electrostatically charged plate(s), the metallic byproducts will be attracted to and collect onto the surface(s) of the electrostatically charged plate(s), thus removing the byproducts from the gas flow. In another example, the one or more electrostatically charged plates have an appropriate voltage (changing the plate(s) with the same charge of the byproducts) applied to the plate(s), the metallic byproducts will be repelled away from the electrostatically charged plate(s). For example, having one or more electrostatically charged plates positioned adjacent beam window 408 and applying an appropriate voltage (changing the plate(s) with the same charge of the byproducts) to the plate(s), the metallic byproducts will be repelled away from the beam window by the electrostatically charged plate(s). Because one or more of the electrostatically charged plate has attracted and/or repelled the byproducts, the portion of the gas flow circulating in an upward direction toward an upper part of the enclosure and/or adjacent the beam window is free or substantially free of the byproducts. As illustrated in FIG. 4, the one or more electrostatically charged plates are positioned on side wall 467 and a voltage is applied, via voltage source 433, to each of the electrostatically charged plates such that the byproducts are attracted to the electrostatically charged plates and the byproducts attach to the surface(s) of the electrostatically charged plates, thus preventing the byproducts from attaching to the beam window and to the material, which is to be fused by the energy beam. In this way, for example, the beam window and the build piece may be kept free or substantially free from byproduct contamination.

The side walls are the walls on the sides of the geometrically shaped enclosure 406. For example, the side walls include the four walls of a square or rectangular shaped enclosure 406. Top wall 466 may include one or more beam windows 408. In various embodiments, the top wall may include optics (See FIG. 4) and one or more beam windows 408. Side wall 467 may include gas inlet 407 and side wall 468 may include gas outlet 408. The gas inlet may be in a lower or upper portion of the side wall and the gas outlet may be in a lower portion or an upper portion of the side wall. In various embodiments, side wall 467 may include a plurality of gas inlets 407 and side wall 468 may include a plurality of gas outlets 408 or side wall 468 may include a plurality of gas inlets 407 and side wall 467 may include a plurality of gas outlets 408. A gas inlet (e.g., a first gas inlet) may be in a lower portion of the side wall and another gas inlet (e.g., a second gas inlet) may be in an upper portion of the same or different side wall. A gas outlet (e.g., a first gas outlet) may be in a lower portion of the side wall and another gas outlet (e.g., a second gas outlet) may be in an upper portion of the same or different side wall.

FIG. 5 illustrates an example embodiment of PBR system 500. PBR system 500 may include the components of PBR systems illustrated in FIGS. 1A-1E, 3-4 and 6-8. PBR system 500 includes enclosure 506, and the enclosure includes top wall 566 and sides walls (e.g., 567,568 and unshown front and back side walls). One or more of the side walls may include one or more gas inlets 507 and may include one or more gas outlets 508.

PBR system 500 includes energy beam source 503, which generates energy beam 527. Energy beam source 503 and/or the deflector 505 can modulate the energy beam, e.g., turn the energy beam on and off as the deflector scans so that the energy beam is applied only in the appropriate areas of a material (e.g., metal powder) of a powder layer within powder bed 521. For example, in various embodiments, the energy beam can be modulated by using signals generated by a digital signal processor (DSP) or other similar signal generating devices or components. The energy beam is applied through beam window 508 by deflector 505 and onto the material in the powder bed in order to fuse/melt the material in the powder bed forming build piece 509. The energy beam applied to the material creates byproducts 510 as the material in the powder bed is being fused in fusion area 504. Fusion of the material in the powder bed may also generate byproducts 510 in other areas of build piece 509 as those areas of build piece 509 cool down after fusion. One or more electrostatically charged plates 522 may be associated with one or more sides walls (e.g., 567,568) and/or top wall 566. In this way, for example, byproducts 510 may be attracted to and collected on the surface(s) of the electrostatically charged plates and/or may repel the byproducts away from a component or components of the PBR system. The repelled byproducts may then be attracted to surfaces of other electrostatically charged plates and/or exit through the one or more gas outlets. More than one energy beam source, more than one deflector and more than one beam window may be included in the PBR system. For example, two or more energy beam sources 503, two or more deflectors 505 and two or more beam windows 508 may be included in the PBR system such that each energy beam source generates an energy beam and each deflector enables each energy beam to be directed through a corresponding beam window of the plurality of windows. In a specific example, a first energy beam source generates a first energy beam and a first deflector enables the first energy beam to be directed through a first beam window and a second energy beam source generates a second energy beam and a second deflector enables the second energy beam to be directed through a second beam window.

A gas source (not shown) supplies a gas such that the gas enters through the one or more gas inlets 507 and exits through the one or more gas outlets 508. The gas provides a gas flow 502 within the build chamber to remove a percentage of the byproducts from the build chamber but as stated above, not all of the byproducts generated by the fusion of the powder are removed from the build chamber by only the gas flow. The gas may be a non-oxidizing gas or an inert gas such as nitrogen, argon, helium, neon, xenon, radon or krypton.

One or more electrostatically charged plates 522 may be arranged in various configurations, e.g., attached to one or more of the side walls and/or the top wall. For example, FIG. 5 illustrates a plurality electrostatically charged plates 522 attached to top wall 566. In various embodiments, a single electrostatically charged plate 522 may be attached to the top wall. The one or more electrostatically charged plates 522 are positioned in various configurations on or within the one or more side walls and/or top wall such that the gas flow including the byproducts attach to the surface(s) of the electrostatically charged plates when a voltage is applied to each of the one or more electrostatically charged plates and/or repel byproducts 510 away from the one or more electrostatically charged plates such that the byproducts exit the one or more outlets without attaching or contacting any beam window 508. Controller 588 is coupled and/or in communication (i.e., wired or wirelessly) with voltage source 533 such that the controller allows voltage from voltage source 533 to be applied to the one or more electrostatically charged plates in order to attract or repel at least a portion of the byproducts in the build chamber. For example, if the material being fused/melted is metallic or an alloy, then some of the byproducts will be metallic and when applying an appropriate voltage (changing the plate(s) with an opposite charge of the byproducts) is applied to the electrostatically charged plate(s), the metallic byproducts will be attracted to and collect onto the surface(s) of the electrostatically charged plate(s), thus removing the byproducts from the gas flow. In another example, the one or more electrostatically charged plates have an appropriate voltage (changing the plate(s) with the same charge of the byproducts) applied to the plate(s), the metallic byproducts will be repelled away from the electrostatically charged plate(s). For example, having one or more electrostatically charged plates positioned adjacent beam window 508 and applying an appropriate voltage (changing the plate(s) with the same charge of the byproducts) to the plate(s), the metallic byproducts will be repelled away from the beam window by the electrostatically charged plate(s). Because one or more of the electrostatically charged plate has attracted and/or repelled the byproducts, the portion of the gas flow circulating in an upward direction toward an upper part of the enclosure and/or adjacent the beam window is free or substantially free of the byproducts. As illustrated in FIG. 5, the one or more electrostatically charged plates are positioned on top wall 566 to the right (i.e. relative to an end of the beam window) of beam window 508 and a voltage is applied, via voltage source 533, to each of the electrostatically charged plates such that the byproducts are attracted to the electrostatically charged plates and the byproducts attach to the surface(s) of the electrostatically charged plates, thus preventing the byproducts from attaching to the beam window and to the material, which is to be fused by the energy beam. In this way, for example, the beam window and the build piece may be kept free or substantially free from byproduct contamination.

The side walls are the walls on the sides of the geometrically shaped enclosure 506. For example, the side walls include the four walls of a square or rectangular shaped enclosure 506. Top wall 566 may include one or more beam windows 508. In various embodiments, the top wall may include optics (See FIG. 4) and one or more beam windows 508. Side wall 567 may include gas inlet 507 and side wall 568 may include gas outlet 508. The gas inlet may be in a lower or upper portion of the side wall and the gas outlet may be in a lower portion or an upper portion of the same or different side wall. In various embodiments, side wall 567 may include a plurality of gas inlets 507 and side wall 568 may include a plurality of gas outlets 508 or side wall 568 may include a plurality of gas inlets 507 and side wall 567 may include a plurality of gas outlets 508. A gas inlet (e.g., a first gas inlet) may be in a lower portion of the side wall and another gas inlet (e.g., a second gas inlet) may be in an upper portion of the same or different side wall. A gas outlet (e.g., a first gas outlet) may be in a lower portion of the side wall and another gas outlet (e.g., a second gas outlet) may be in an upper portion of the same or different side wall.

FIG. 6 illustrates an example embodiment of PBR system 600. PBR system 600 may include the components of PBR systems illustrated in FIGS. 1A-1E, 3-5 and 7-8. PBR system 600 includes enclosure 606, and the enclosure includes top wall 666 and sides walls (e.g., 667,668 and unshown front and back side walls). One or more of the side walls may include one or more gas inlets 607 and may include one or more gas outlets 608.

PBR system 600 includes energy beam source 603, which generates energy beam 627. Energy beam source 603 and/or the deflector 605 can modulate the energy beam, e.g., turn the energy beam on and off as the deflector scans so that the energy beam is applied only in the appropriate areas of a material (e.g., metal powder) of a powder layer within powder bed 621. For example, in various embodiments, the energy beam can be modulated by using signals generated by a digital signal processor (DSP) or other similar signal generating devices or components. The energy beam is applied through beam window 608 by deflector 605 and onto the material in the powder bed in order to fuse/melt the material in the powder bed forming build piece 609. The energy beam applied to the material creates byproducts 610 as the material in the powder bed is being fused in fusion area 604. Fusion of the material in the powder bed may also generate byproducts 610 in other areas of build piece 609 as those areas of build piece 609 cool down after fusion. One or more electrostatically charged plates 622 may be associated with one or more sides walls (e.g., 667,668) and/or top wall 666. In this way, for example, byproducts 610 may be attracted to and collected on the surface(s) of the electrostatically charged plates and/or may repel the byproducts away from a component or components of the PBR system. The repelled byproducts may then be attracted to surfaces of other electrostatically charged plates and/or exit through the one or more gas outlets. More than one energy beam source, more than one deflector and more than one beam window may be included in the PBR system. For example, two or more energy beam sources 603, two or more deflectors 605 and two or more beam windows 608 may be included in the PBR system such that each energy beam source generates an energy beam and each deflector enables each energy beam to be directed through a corresponding beam window of the plurality of windows. In a specific example, a first energy beam source generates a first energy beam and a first deflector enables the first energy beam to be directed through a first beam window and a second energy beam source generates a second energy beam and a second deflector enables the second energy beam to be directed through a second beam window.

A gas source (not shown) supplies a gas such that the gas enters through the one or more gas inlets 607 and exits through the one or more gas outlets 608. The gas provides a gas flow 602 within the build chamber to remove a percentage of the byproducts from the build chamber but as stated above, not all of the byproducts generated by the fusion of the powder are removed from the build chamber by only the gas flow. The gas may be a non-oxidizing gas or an inert gas such as nitrogen, argon, helium, neon, xenon, radon or krypton.

One or more electrostatically charged plates 622 may be arranged in various configuration, e.g., attached s to one or more of the side walls and/or the top wall. For example, FIG. 6 illustrates a plurality of electrostatically charged plates 622 attached to top wall 666. In various embodiments, a single electrostatically charged plate 622 may be attached to top wall 666. The one or more electrostatically charged plates 622 are positioned in various configurations on or within the one or more side walls and/or top wall such that the gas flow including the byproducts attach to the surface(s) of the electrostatically charged plates when a voltage is applied to each of the one or more electrostatically charged plates and/or repel byproducts 610 away from the one or more electrostatically charged plates such that the byproducts exit the one or more outlets without attaching or contacting any beam window 608. Controller 688 is coupled and/or in communication (i.e., wired or wirelessly) with voltage source 633 such that the controller allows voltage from voltage source 633 to be applied to the one or more electrostatically charged plates in order to attract or repel at least a portion of the byproducts in the build chamber. For example, if the material being fused/melted is metallic or an alloy, then some of the byproducts will be metallic and when applying an appropriate voltage (changing the plate(s) with an opposite charge of the byproducts) is applied to the electrostatically charged plate(s), the metallic byproducts will be attracted to and collect onto the surface(s) of the electrostatically charged plate(s), thus removing the byproducts from the gas flow. In another example, the one or more electrostatically charged plates have an appropriate voltage (changing the plate(s) with the same charge of the byproducts) applied to the plate(s), the metallic byproducts will be repelled away from the electrostatically charged plate(s). For example, having one or more electrostatically charged plates positioned adjacent beam window 608 and applying an appropriate voltage (changing the plate(s) with the same charge of the byproducts) to the plate(s), the metallic byproducts will be repelled away from the beam window by the electrostatically charged plate(s). Because one or more of the electrostatically charged plate has attracted and/or repelled the byproducts, the portion of the gas flow circulating in an upward direction toward an upper part of the enclosure and/or adjacent the beam window is free or substantially free of the byproducts. As illustrated in FIG. 6, the one or more electrostatically charged plates are positioned on top wall 666 to the left (i.e. relative to an end of the beam window) of beam window 608 and a voltage is applied, via voltage source 633, to each of the electrostatically charged plates such that the byproducts are attracted to the electrostatically charged plates and the byproducts attach to the surface(s) of the electrostatically charged plates, thus preventing the byproducts from attaching to the beam window and to the material, which is to be fused by the energy beam. In this way, for example, the beam window and the build piece may be kept free or substantially free from byproduct contamination.

The side walls are the walls on the sides of the geometrically shaped enclosure 606. For example, the side walls include the four walls of a square or rectangular shaped enclosure 606. Top wall 666 may include one or more beam windows 608. In various embodiments, the top wall may include optics (See FIG. 4) and one or more beam windows 608. Side wall 667 may include gas inlet 607 and side wall 668 may include gas outlet 608. The gas inlet may be in a lower or upper portion of the side wall and the gas outlet may be in a lower portion or an upper portion of the same or different side wall. In various embodiments, side wall 667 may include a plurality of gas inlets 607 and side wall 668 may include a plurality of gas outlets 608 or side wall 668 may include a plurality of gas inlets 607 and side wall 667 may include a plurality of gas outlets 608. A gas inlet (e.g., a first gas inlet) may be in a lower portion of the side wall and another gas inlet (e.g., a second gas inlet) may be in an upper portion of the same or different side wall. A gas outlet (e.g., a first gas outlet) may be in a lower portion of the side wall and another gas outlet (e.g., a second gas outlet) may be in an upper portion of the same or different side wall.

FIG. 7 illustrates an example embodiment of PBR system 700. PBR system 700 may include the components of PBR systems illustrated in FIGS. 1A-1E, 3-6 and 8. PBR system 700 includes enclosure 706, and the enclosure includes top wall 766 and sides walls (e.g., 767,768 and unshown front and back side walls). One or more of the side walls may include one or more gas inlets 707 and may include one or more gas outlets 708.

PBR system 700 includes energy beam source 703, which generates energy beam 727. Energy beam source 703 and/or the deflector 705 can modulate the energy beam, e.g., turn the energy beam on and off as the deflector scans so that the energy beam is applied only in the appropriate areas of a material (e.g., metal powder) of a powder layer within powder bed 721. For example, in various embodiments, the energy beam can be modulated by using signals generated by a digital signal processor (DSP) or other similar signal generating devices or components. The energy beam is applied through beam window 708 by deflector 705 and onto the material in the powder bed in order to fuse/melt the material in the powder bed forming build piece 709. The energy beam applied to the material creates byproducts 710 as the material in the powder bed is being fused in fusion area 704. Fusion of the material in the powder bed may also generate byproducts 710 in other areas of build piece 709 as those areas of build piece 709 cool down after fusion. One or more electrostatically charged plates 722 may be associated with one or more sides walls (e.g., 767,768) and/or top wall 766. In this way, for example, byproducts 710 may be attracted to and collected on the surface(s) of the electrostatically charged plates and/or may repel the byproducts away from a component or components of the PBR system. The repelled byproducts may then be attracted to surfaces of other electrostatically charged plates and/or exit through the one or more gas outlets. More than one energy beam source, more than one deflector and more than one beam window may be included in the PBR system. For example, two or more energy beam sources 703, two or more deflectors 705 and two or more beam windows 708 may be included in the PBR system such that each energy beam source generates an energy beam and each deflector enables each energy beam to be directed through a corresponding beam window of the plurality of windows. In a specific example, a first energy beam source generates a first energy beam and a first deflector enables the first energy beam to be directed through a first beam window and a second energy beam source generates a second energy beam and a second deflector enables the second energy beam to be directed through a second beam window.

A gas source (not shown) supplies a gas such that the gas enters through the one or more gas inlets 707 and exits through the one or more gas outlets 708. The gas provides a gas flow 702 within the build chamber to remove a percentage of the byproducts from the build chamber but as stated above, not all of the byproducts generated by the fusion of the powder are removed from the build chamber by only the gas flow. The gas may be a non-oxidizing gas or an inert gas such as nitrogen, argon, helium, neon, xenon, radon or krypton.

One or more electrostatically charged plates 722 may be arranged in various configurations, e.g., attached to one or more of the side walls and/or the top wall. For example, FIG. 7 illustrates a plurality electrostatically charged plates 722 attached to top wall 766, and side wall 767. In various embodiments, a single electrostatically charged plate 722 may be attached to top wall 766 and side wall 767 or a single electrostatically charged plates 722 may be attached to top wall 766, side wall 767 and side wall 768. The one or more electrostatically charged plates 722 are arranged in various configurations, e.g., attached on or within the one or more side walls and/or the top wall. In this way, for example, the byproducts may be attracted to and collected to the surface(s) of the electrostatically charged plates when a voltage is applied to each of the one or more electrostatically charged plates and/or may repel byproducts 710 away from the one or more electrostatically charged plates such that the byproducts exit the one or more outlets without attaching or contacting any beam window 708. A controller (e.g., 788,789,790) is coupled and/or in communication (i.e., wired or wirelessly) with each voltage source (e.g., 733,734,735) such that the controller may allow voltage from the voltage source to be applied to the one or more electrostatically charged plates. In this way, for example, at least a portion of the byproducts may be attracted to and collected on the surface(s) of the electrostatically charged plates and/or may repel the byproducts away from a component or components of the PBR system. For example, if the material being fused/melted is metallic or an alloy, then some of the byproducts will be metallic and when applying an appropriate voltage (changing the plate(s) with an opposite charge of the byproducts) is applied to the electrostatically charged plate(s), the metallic byproducts will be attracted to and collect onto the surface(s) of the electrostatically charged plate(s), thus removing the byproducts from the gas flow. In another example, the one or more electrostatically charged plates have an appropriate voltage (changing the plate(s) with the same charge of the byproducts) applied to the plate(s), the metallic byproducts will be repelled away from the electrostatically charged plate(s). For example, having one or more electrostatically charged plates positioned adjacent beam window 708 and applying an appropriate voltage (changing the plate(s) with the same charge of the byproducts) to the plate(s), the metallic byproducts will be repelled away from the beam window by the electrostatically charged plate(s). Because one or more of the electrostatically charged plate has attracted and/or repelled the byproducts, the portion of the gas flow circulating in an upward direction toward an upper part of the enclosure and/or adjacent the beam window is free or substantially free of the byproducts. Controllers 788, 789 and 790 are configured to enable voltage sources 733, 734 and 735 to apply voltage to the one or more electrostatically charged plates in order to attract or repel at least a portion of the byproducts in the build chamber. In various embodiments, one controller may be coupled to one or more voltage sources. For example, one controller may be coupled to one voltage source such that a voltage is applied to all electrostatically charged plates via wires coupled between the voltage source and the electrostatically charged plates. As illustrated in FIG. 7, the one or more electrostatically charged plates are positioned on top wall 766 to the left (i.e. relative to an end of the beam window) and the right (i.e. relative to an end of the beam window) of beam window 708 and on side wall 767. A voltage is applied, via voltage sources 733, 734 and 735, to the electrostatically charged plates such that the byproducts are attracted to the electrostatically charged plates and the byproducts attach to the surface(s) of the electrostatically charged plates, thus preventing the byproducts from attaching to the beam window and to the material, which is to be fused by the energy beam. In this way, for example, the beam window and the build piece may be kept free or substantially free from byproduct contamination.

The side walls are the walls on the sides of the geometrically shaped enclosure 706. For example, the side walls include the four walls of a square or rectangular shaped enclosure 706. Top wall 766 may include one or more beam windows 708. In various embodiments, the top wall may include optics (See FIG. 4) and one or more beam windows 708. Side wall 767 may include gas inlet 707 and side wall 768 may include gas outlet 708. The gas inlet may be in a lower or upper portion of the side wall and the gas outlet may be in a lower portion or an upper portion of the same or different side wall. In various embodiments, side wall 767 may include a plurality of gas inlets 707 and side wall 768 may include a plurality of gas outlets 708 or side wall 768 may include a plurality of gas inlets 707 and side wall 767 may include a plurality of gas outlets 708. A gas inlet (e.g., a first gas inlet) may be in a lower portion of the side wall and another gas inlet (e.g., a second gas inlet) may be in an upper portion of the same or different side wall. A gas outlet (e.g., a first gas outlet) may be in a lower portion of the side wall and another gas outlet (e.g., a second gas outlet) may be in an upper portion of the same or different side wall.

FIG. 8 illustrates an example embodiment of PBR system 800. PBR system 800 may include the components of PBR systems illustrated in FIGS. 1A-1E and 3-7. PBR system 800 includes enclosure 806, and the enclosure includes top wall 866 and sides walls (e.g., 867,868 and unshown front and back side walls). One or more of the side walls may include one or more gas inlets 807 and may include one or more gas outlets 808.

PBR system 800 includes energy beam source 803, which generates energy beam 827. Energy beam source 803 and/or the deflector 805 can modulate the energy beam, e.g., turn the energy beam on and off as the deflector scans so that the energy beam is applied only in the appropriate areas of a material (e.g., metal powder) of a powder layer within powder bed 821. For example, in various embodiments, the energy beam can be modulated by using signals generated by a digital signal processor (DSP) or other similar signal generating devices or components. The energy beam is applied through beam window 808 by deflector 805 and onto the material in the powder bed in order to fuse/melt the material in the powder bed forming build piece 809. The energy beam applied to the material creates byproducts 810 as the material in the powder bed is being fused in fusion area 804. Fusion of the material in the powder bed may also generate byproducts 810 in other areas of build piece 809 as those areas of build piece 809 cool down after fusion. One or more electrostatically charged plates 822 may be associated with one or more sides walls (e.g., 867,868) and/or top wall 866. In this way, for example, byproducts 810 may be attracted to and collected on the surface(s) of the electrostatically charged plates and/or may repel the byproducts away from a component or components of the PBR system. The repelled byproducts may then be attracted to surfaces of other electrostatically charged plates and/or exit through the one or more gas outlets. More than one energy beam source, more than one deflector and more than one beam window may be included in the PBR system. For example, two or more energy beam sources 803, two or more deflectors 805 and two or more beam windows 808 may be included in the PBR system such that each energy beam source generates an energy beam and each deflector enables each energy beam to be directed through a corresponding beam window of the plurality of windows. In a specific example, a first energy beam source generates a first energy beam and a first deflector enables the first energy beam to be directed through a first beam window and a second energy beam source generates a second energy beam and a second deflector enables the second energy beam to be directed through a second beam window.

A gas source (not shown) supplies a gas such that the gas enters through the one or more gas inlets 807 and exits through the one or more gas outlets 808. The gas provides a gas flow 802 within the build chamber to remove a percentage of the byproducts from the build chamber but as stated above, not all of the byproducts generated by the fusion of the powder are removed from the build chamber by only the gas flow. The gas may be a non-oxidizing gas or an inert gas such as nitrogen, argon, helium, neon, xenon, radon or krypton.

One or more electrostatically charged plates 822 may be arranged in various configurations, e.g., attached to one or more of the side walls and/or the top wall. For example, FIG. 8 illustrates a plurality electrostatically charged plates 822 attached to top wall 866 and arranged around an outer perimeter of beam window 808, as better seen in the illustration of FIG. 9. In various embodiments, a single electrostatically charged plate 822 may be attached to top wall 866 and one or more side walls. FIG. 9 illustrates a top view of beam window 808 and electrostatically charged plates 822 within FIG. 8. FIG. 9 illustrates the electrostatically charged plates 822 arranged in a circular configuration around an outer perimeter of the beam window. In various embodiments, a single, the electrostatically charged plates may form any geometry configuration around the outer perimeter of the beam window. The one or more electrostatically charged plates 822 are positioned in various configurations on or within the one or more side walls and/or the top wall such that the gas flow including the byproducts attach to the surface(s) of the electrostatically charged plates when a voltage is applied to each of the one or more electrostatically charged plates and/or repel byproducts 810 away from the one or more electrostatically charged plates such that the byproducts exit the one or more outlets without attaching or contacting any beam window 808. For example, if the material being fused/melted is metallic or an alloy, then some of the byproducts will be metallic and when applying an appropriate voltage (changing the plate(s) with an opposite charge of the byproducts) is applied to the electrostatically charged plate(s), the metallic byproducts will be attracted to and collect onto the surface(s) of the electrostatically charged plate(s), thus removing the byproducts from the gas flow. In another example, the one or more electrostatically charged plates have an appropriate voltage (changing the plate(s) with the same charge of the byproducts) applied to the plate(s), the metallic byproducts will be repelled away from the electrostatically charged plate(s). Because one or more of the electrostatically charged plate has attracted and/or repelled the byproducts, the portion of the gas flow circulating in an upward direction toward an upper part of the enclosure and/or adjacent the beam window is free or substantially free of the byproducts. As illustrated in FIGS. 8 and 9, one or more electrostatically charged plates 822 are positioned around an outer perimeter of window 808 and when an appropriate voltage (changing the plate(s) with the same charge of the byproducts) is applied to the plate(s), the metallic byproducts will be repelled away from the beam window by the electrostatically charged plate(s). Controller 888 is coupled and/or in communication (i.e., wired or wirelessly) with voltage source 833 such that the controller allows voltage from voltage source 833 to be applied to the one or more electrostatically charged plates in order to attract and/or repel at least a portion of the byproducts in the build chamber. Voltage source 833 applies a voltage to the one or more electrostatically charged plates in order to repel at least a portion of the byproducts in the build chamber. As illustrated in FIG. 8, the one or more electrostatically charged plates are positioned on top wall 866 and around an outer perimeter of beam window 808. A voltage is applied, via voltage source 833 to the electrostatically charged plates such that the byproducts are repelled by the electrostatically charged plates and away from beam window 808, thus preventing the byproducts from attaching to the beam window and to the material, which is to be fused by the energy beam. In this way, for example, the beam window and the build piece may be kept free or substantially free from byproduct contamination.

The side walls are the walls on the sides of the geometrically shaped enclosure 806. For example, the side walls include the four walls of a square or rectangular shaped enclosure 806. Top wall 866 may include one or more beam windows 808. In various embodiments, the top wall may include optics (See FIG. 4) and one or more beam windows 808. Side wall 867 may include gas inlet 807 and side wall 868 may include gas outlet 808. The gas inlet may be in a lower or upper portion of the side wall and the gas outlet may be in a lower portion or an upper portion of the same or different side wall. In various embodiments, side wall 867 may include a plurality of gas inlets 807 and side wall 868 may include a plurality of gas outlets 808 or side wall 868 may include a plurality of gas inlets 807 and side wall 867 may include a plurality of gas outlets 808. A gas inlet (e.g., a first gas inlet) may be in a lower portion of the side wall and another gas inlet (e.g., a second gas inlet) may be in an upper portion of the same or different side wall. A gas outlet (e.g., a first gas outlet) may be in a lower portion of the side wall and another gas outlet (e.g., a second gas outlet) may be in an upper portion of the same or different side wall.

FIG. 10 illustrates an example embodiment of PBR system 1000. PBR system 1000 may include the components of PBR systems illustrated in FIGS. 1A-1E and 3-8. PBR system 1000 includes enclosure 1006, and the enclosure includes top wall 1066 and sides walls (e.g., 1067,1068 and unshown front and back side walls). One or more of the side walls may include one or more gas inlets 1007 and may include one or more gas outlets 1008.

PBR system 1000 includes energy beam source 1003, which generates energy beam 1027. Energy beam source 1003 and/or the deflector 1005 can modulate the energy beam, e.g., turn the energy beam on and off as the deflector scans so that the energy beam is applied only in the appropriate areas of a material (e.g., metal powder) of a powder layer within powder bed 1021. For example, in various embodiments, the energy beam can be modulated by using signals generated by a digital signal processor (DSP) or other similar signal generating devices or components. The energy beam is applied through beam window 1008 by deflector 1005 and onto the material in the powder bed in order to fuse/melt the material in the powder bed forming build piece 1009. The energy beam applied to the material creates byproducts 1010 as the material in the powder bed is being fused in fusion area 1004. Fusion of the material in the powder bed may also generate byproducts 1010 in other areas of build piece 1009 as those areas of build piece 1009 cool down after fusion. Film 1022,1023 or a plurality of films may be associated with beam window 1008. In this way, for example, byproducts 1010 may be repelled away from the beam window and/or other components of the PBR system. The repelled byproducts may then be repelled away from the surface(s) of one or more beam windows and exit through the one or more gas outlets. More than one energy beam source, more than one deflector and more than one beam window may be included in the PBR system. For example, two or more energy beam sources 1003, two or more deflectors 1005 and two or more beam windows 1008 may be included in the PBR system such that each energy beam source generates an energy beam and each deflector enables each energy beam to be directed through a corresponding beam window of the plurality of windows. In a specific example, a first energy beam source generates a first energy beam and a first deflector enables the first energy beam to be directed through a first beam window and a second energy beam source generates a second energy beam and a second deflector enables the second energy beam to be directed through a second beam window.

A gas source (not shown) supplies a gas such that the gas enters through the one or more gas inlets 1007 and exits through the one or more gas outlets 1008. The gas provides a gas flow 1002 within the build chamber to remove a percentage of the byproducts from the build chamber but as stated above, not all of the byproducts generated by the fusion of the powder are removed from the build chamber by only the gas flow. The gas may be a non-oxidizing gas or an inert gas such as nitrogen, argon, helium, neon, xenon, radon or krypton.

Film 1022,1023 or a plurality of films may be arranged in various configurations, e.g., attached to one or portions of beam window 1008. For example, FIG. 10 illustrates film 1022,1023 attached to beam window 1008 outside length L of beam angle 1080. In various embodiments, a plurality of films may be attached to beam window 1008. Beam angle 1080 is an angle, which the energy beam makes a maximum deflection from a vertical (i.e., on axis) direction during the manufacture of the build piece. The film or a plurality of films are arranged in various configurations, e.g., attached on one or more beam windows. In this way, for example, the gas flow including the byproducts are repelled away from the beam window(s) when a voltage is applied to the film(s) such that the byproducts may exit the one or more outlets without attaching or contacting the beam window(s). Controller (e.g., 1088, 1089) is coupled and/or in communication (i.e., wired or wirelessly) with each voltage source (e.g., 1033, 1034). In this way, for example, the controller may allow voltage from the voltage source to be applied to the one or more film so at least a portion of the byproducts may be repelled away from the one or more film. In various embodiments, one controller may be coupled to the one or more voltage sources. For example, one controller may be coupled to one voltage source such that a voltage is applied to the one or more film via wires coupled between the voltage source and the electrostatically charged plates. One or more voltage sources 1033,1034 applies a voltage to the film(s) in order to repel at least a portion of the byproducts in the build chamber. For example, if the material being fused/melted is metallic or an alloy, then some of the byproducts will be metallic and when applying an appropriate voltage (changing the film(s) with the same charge of the byproducts) is applied to the film(s), the metallic byproducts will be repelled away from the surface(s) of the beam window(s). Because one or more of the film has repelled the byproducts, the portion of the gas flow circulating in an upward direction toward an upper part of the enclosure and/or adjacent the beam window is free or substantially free of the byproducts. As illustrated in FIG. 10, the film or a plurality of films are positioned on beam window 1008 and a voltage is applied to film 1022 via voltage source 1034 and a voltage is applied to film 1023 via voltage source 1033 such that the byproducts are repelled away from the surface of beam window 1008, thus preventing the byproducts from attaching to the beam window and to the material, which is to be fused by the energy beam. In this way, for example, the beam window and the build piece may be kept free or substantially free from byproduct contamination. The film includes a metallic material. The metallic material may include an alloy.

The side walls are the walls on the sides of the geometrically shaped enclosure 1006. For example, the side walls include the four walls of a square or rectangular shaped enclosure 1006. Top wall 1066 may include one or more beam windows 1008. In various embodiments, the top wall may include optics (See FIG. 4) and one or more beam windows 1008. Side wall 1067 may include gas inlet 1007 and side wall 1068 may include gas outlet 1008. The gas inlet may be in a lower or upper portion of the side wall and the gas outlet may be in a lower portion or an upper portion of the same or different side wall. In various embodiments, side wall 1067 may include a plurality of gas inlets 1007 and side wall 1068 may include a plurality of gas outlets 1008 or side wall 1068 may include a plurality of gas inlets 1007 and side wall 1067 may include a plurality of gas outlets 1008. A gas inlet (e.g., a first gas inlet) may be in a lower portion of the side wall and another gas inlet (e.g., a second gas inlet) may be in an upper portion of the same or different side wall. A gas outlet (e.g., a first gas outlet) may be in a lower portion of the side wall and another gas outlet (e.g., a second gas outlet) may be in an upper portion of the same or different side wall.

FIG. 11 illustrates electrostatically charged plates arranged in a configuration, wherein the configuration of the electrostatically charged plates may be provided within various embodiments. Electrostatically charged plates 1122 are arranged in a staircase configuration. For example, the electrostatically charged plates have a first end and a second end and the first end of one plate extents further in a horizontal direction than the first end of another plate. The electrostatically charged plates 1122 may be considered to be arranged in an offset configuration (i.e., not vertically aligned). Additionally or alternatively, two or more electrostatically charged plates 1122 may be parallel or non-parallel. Additionally or alternatively, the electrostatically charged plates are not in vertical or horizontal alignment. Vertically aligned is where the plates first and second ends terminate at the same distance in the horizontal direction (i.e., the x-direction in the standard x-y-z coordinate system). Horizontally aligned is where the plates sides terminate at the same distance in a direction perpendicular to the page of FIG. 12. Two or more electrostatically charged plates 1122 may be parallel or non-parallel.

FIG. 12 illustrates electrostatically charged plates arranged in a configuration, wherein the configuration of the electrostatically charged plates may be provided within various embodiments. Electrostatically charged plates 1222 are arranged in alignment. For example, the electrostatically charged plates have a first end and a second end and the first ends of the plates terminate at the same distance in the horizontal direction. Additionally or alternatively, two or more electrostatically charged plates 1222 may be parallel or non-parallel. Additionally or alternatively, the electrostatically charged plates may not be vertically aligned.

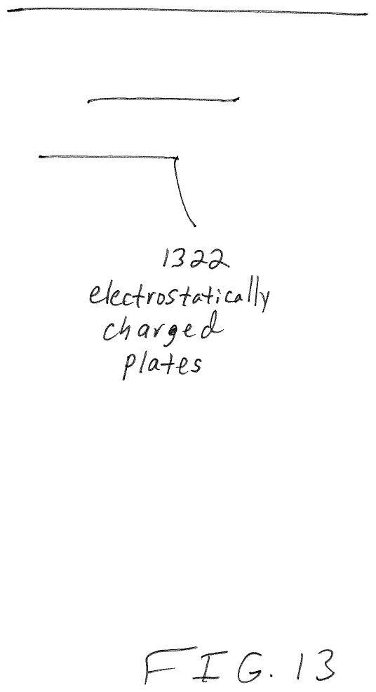

FIG. 13 illustrates electrostatically charged plates arranged in a configuration, wherein the configuration of the electrostatically charged plates may be provided within various embodiments. Electrostatically charged plates 1322 are arranged in an offset configuration. For example, the electrostatically charged plates have a first end and a second end and each of the first and second ends of the plates terminate at different horizontal direction distances. Additionally or alternatively, two or more electrostatically charged plates 1322 may be parallel or non-parallel.

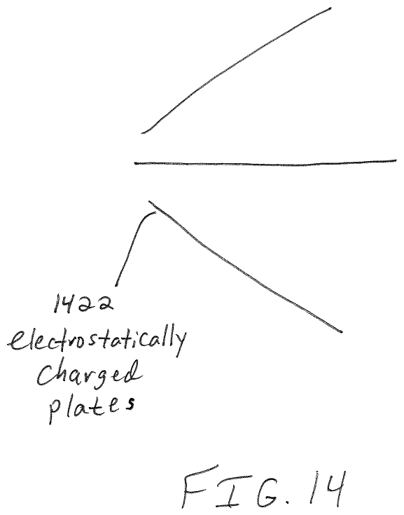

FIG. 14 illustrates electrostatically charged plates arranged in a configuration, wherein the configuration of the electrostatically charged plates may be provided within various embodiments. Electrostatically charged plates 1422 are arranged in a non-parallel configuration. For example, an angle between two of the electrostatically charged plates is not 180 degrees.

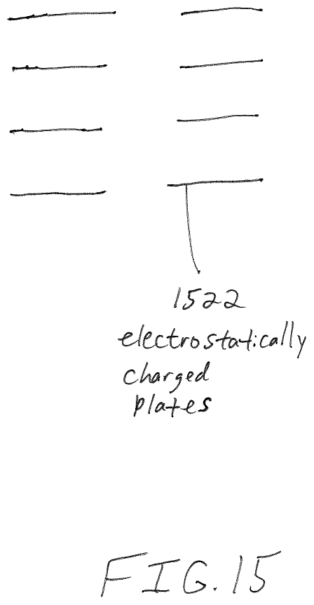

FIG. 15 illustrates electrostatically charged plates arranged in a configuration, wherein the configuration of the electrostatically charged plates may be provided within various embodiments. Electrostatically charged plates 1522 are arranged in an array configuration. Electrostatically charged plates 1522 may be considered to be arranged in a grid configuration. Also, electrostatically charged plates 1522 may be considered to be arranged in a vertical alignment configuration. For example, the electrostatically charged plates 1522 may include more than one row of electrostatically charged plates. Additionally or alternatively, two or more electrostatically charged plates 1522 may be parallel or non-parallel. Additionally or alternatively, the electrostatically charged plates may vertically aligned or not vertically aligned. Additionally or alternatively, two or more electrostatically charged plates may horizontally aligned or not horizontally aligned.

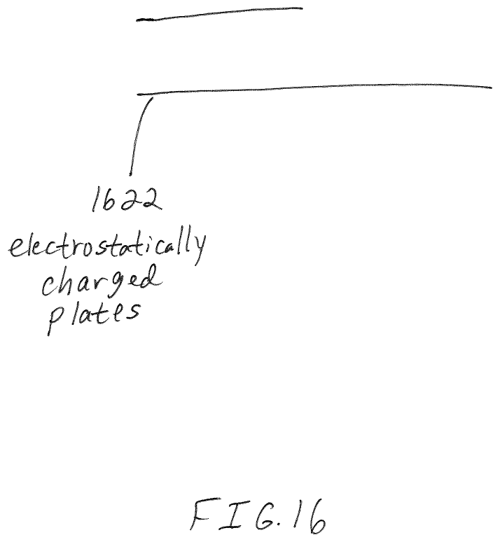

FIG. 16 illustrates electrostatically charged plates arranged in a configuration, wherein the configuration of the electrostatically charged plates may be provided within various embodiments. Electrostatically charged plates 1622 are arranged in an offset configuration. For example, two or more electrostatically charged plates may have each of their first ends terminating at the same horizontal direction distance and their second ends terminating at different horizontal direction distances. Additionally or alternatively, two or more electrostatically charged plates 1622 may be parallel or non-parallel.

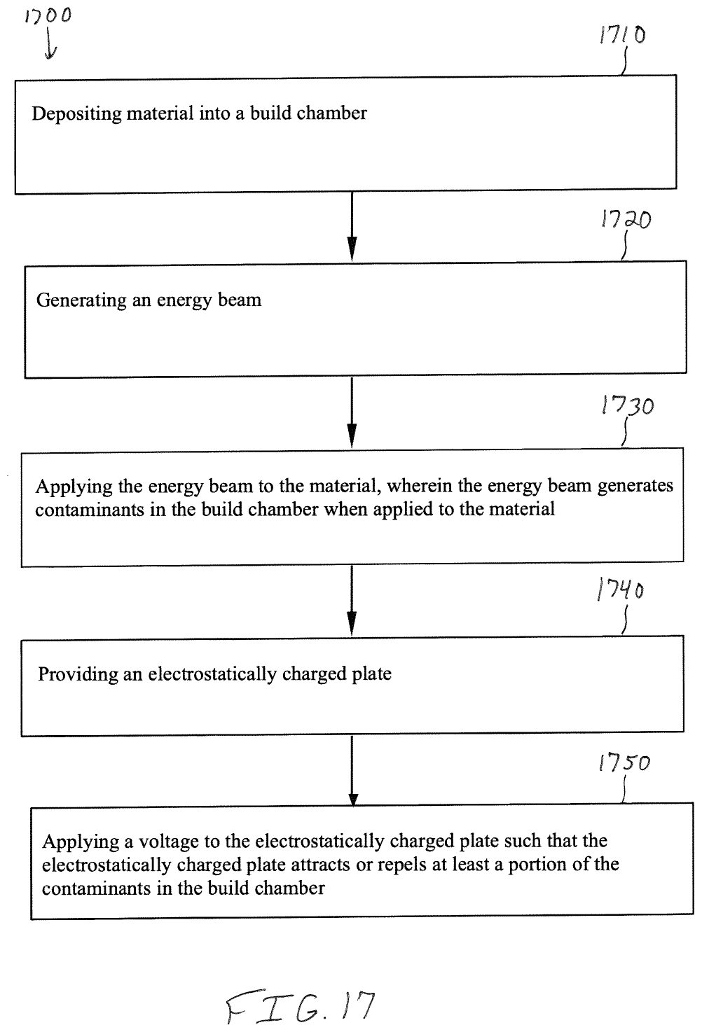

FIG. 17 illustrates a flow diagram showing an example method 1700 in accordance with an aspect of the present disclosure. Method 1700 removes byproducts from a build chamber of various embodiments. Method 1700 removes byproducts in a three dimension (3-D) printer and/or system and includes depositing material into a build chamber 1710, generating an energy beam 1720, applying the energy beam to the material, wherein the energy beam generates contaminants in the build chamber when applied to the material 1730, providing an electrostatically charged plate 1740 and applying a voltage to the electrostatically charged plate such that the electrostatically charged plate attracts or repels at least a portion of the contaminants in the build chamber 1750.

The method further includes coupling a beam entry window to the build chamber such that the beam entry window is configured to pass the energy beam into the build chamber and positioning the electrostatically charged plate in a configuration to prevent the contaminants from depositing on the beam entry window.

The method further includes providing a first voltage to a first plate of a plurality of electrostatically charged plates, providing a second voltage to a second plate of the plurality of electrostatically charged plates.

The method further includes providing the second voltage such that the first voltage is different from or the same as the second voltage.

The method further includes positioning the plurality of electrostatically charged plates on or within one or more walls, including a top wall, of the build chamber and arranging the plurality of electrostatically charged plates in various configurations as well as the configurations illustrated in FIGS. 11-16. For example, the plurality of electrostatically charged plates may be arranged in of an offset configuration, a grid configuration, or a non-parallel configuration. The offset configuration comprises the plurality of electrostatically charged plates not positioned horizontally aligned or not positioned vertically aligned.

The method further includes arranging a first plate and a second plate of the plurality of electrostatically charged plates such that at least one gap is between the first plate and the second plate or between any of the plates.

The method further includes providing a voltage to one or more of the electrostatically charged plates to repel the contaminants away from the beam entry window.

The method further includes providing a voltage to one or more of the electrostatically charged plates to attract the contaminants.

The method of further includes changing the voltage on the electrostatically charged plate such that the electrostatically charged plate changes from attracting the contaminants to repelling the contaminants or from repelling the contaminants to attracting the contaminants.

It is noted that the aforementioned operations are provided as examples. While some specific examples are given, one having ordinary skill in the art would understand that additional possibilities of automated, semi-automated, or manual control of the systems and devices of the disclosed support system formation and removal methods and apparatuses described herein would fall within the scope of this disclosure after understanding the disclosure provided herein.

In addition, aspects of the present disclosures may be implemented using hardware, software, or a combination thereof and may be implemented in one or more computers or computer systems, processors or other processing systems. In an aspect of the present disclosures, features are directed toward one or more computers, processors or computer systems capable of carrying out the functionality described herein.

Computer programs (also referred to as computer control logic) may be stored in a memory in a controller and/or secondary memory. Such computer programs, when executed, enable the apparatus to perform the features in accordance with aspects of the present disclosures, as discussed herein. In particular, the computer programs, when executed, enable the controller to perform the features in accordance with aspects of the present disclosures.

In an aspect of the present disclosures where the method is implemented using software, the software may be stored in a computer program product and loaded into a computer 150 using a removable storage drive, a hard drive, or interface(s). The control logic (software), when executed by a processor, causes the processor to perform the functions described herein.

Reference throughout this specification to one aspect, an aspect, one example or an example means that a particular feature, structure or characteristic described in connection with the embodiment or example may be a feature included in at least example of the present invention. Thus, appearances of the phrases in one aspect, in an aspect, one example or an example in various places throughout this specification are not necessarily all referring to the same example. Furthermore, the particular features, structures or characteristics may be combined in any suitable combinations and/or sub-combinations in one or more embodiments or examples.

Throughout the disclosure, the terms substantially or approximately may be used as a modifier for a geometric relationship between elements or for the shape of an element or component. While the terms substantially or approximately are not limited to a specific variation and may cover any variation that is understood by one of ordinary skill in the art to be an acceptable level of variation, some examples are provided as follows. In one example, the term substantially or approximately may include a variation of less than 10% of the dimension of the object or component. In another example, the term substantially or approximately may include a variation of less than 5% of the object or component. If the term substantially or approximately is used to define the angular relationship of one element to another element, one non-limiting example of the term substantially or approximately may include a variation of five degrees or less. These examples are not intended to be limiting and may be increased or decreased based on the understanding of acceptable limits to one of skill in the relevant art.

For purposes of the disclosure, directional terms are expressed generally with relation to a standard frame of reference when the aspects or articles described herein are in an in-use orientation. In some examples, the directional terms are expressed generally with relation to a left-hand coordinate system.

Terms such as a, an, and the, are not intended to refer to only a singular entity, but also include the general class of which a specific example may be used for illustration. The terms a, an, and the, may be used interchangeably with the term at least one. The phrases at least one of and comprises at least one of followed by a list refers to any one of the items in the list and any combination of two or more items in the list. All numerical ranges are inclusive of their endpoints and non-integer values between the endpoints unless otherwise stated.

The terms source, first, second, third, and fourth, among other numeric values, may be used in this disclosure. It will be understood that, unless otherwise noted, those terms are used in their relative sense only. In particular, certain components may be present in interchangeable and/or identical multiples (e.g., pairs). For these components, the designation of source, first, second, third, and/or fourth may be applied to the components merely as a matter of convenience in the description.

The terms powder bed fusion (PBF) is used throughout the disclosure. PBF systems may encompass a wide variety of additive manufacturing (AM) techniques, systems, and methods. Thus, the PBF system or process as referenced in the disclosure may include, among others, the following printing techniques: direct metal laser sintering (DMLS), electron beam melting (EBM), selective heat sintering (SHS), selective laser melting (SLM) and selective laser sintering (SLS). Still other PBF processes to which the principles of this disclosure are pertinent include those that are currently contemplated or under commercial development. The aspects of the disclosure may additionally be relevant to non-metal additive manufacturing and or metal/adhesive additive manufacturing (e.g., binder jetting), which may forgo an energy beam source and instead apply an adhesive or other bonding agent to form each layer. In the case of binder jetting, the cured or green form may be sintered or fused in a furnace and/or be infiltrated with bronze or other alloys.

The detailed description set forth above in connection with the appended drawings is intended to provide a description of various example embodiments of the concepts disclosed herein and is not intended to represent the only embodiments in which the disclosure may be practiced. The terms “exemplary” and “example” used in this disclosure mean “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the concepts to those skilled in the art. However, the disclosure may be practiced without these specific details. In some instances, well-known structures and components may be shown in block diagram form, or omitted entirely, in order to avoid obscuring the various concepts presented throughout this disclosure.

The previous description is provided to enable any person skilled in the art to practice the various aspects described herein. Various modifications to these example embodiments presented throughout this disclosure will be readily apparent to those skilled in the art. Thus, the claims are not intended to be limited to the example embodiments presented throughout the disclosure, but are to be accorded the full scope consistent with the language claims. All structural and functional equivalents to the elements of the example embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. An apparatus for additive manufacturing, comprising:
a build chamber;
a material depositor configured to deposit a material;
an energy beam source configured to generate an energy beam and apply the energy beam to the material, wherein the energy beam generates contaminants in the build chamber when applied to the material; and
an electrostatically charged plate configured to attract or repel at least a portion of the contaminants in the build chamber.

2. The apparatus of claim 1, wherein the build chamber comprises a wall, and wherein the electrostatically charged plate is integral with or coupled to the wall.

3. The apparatus of claim 1, further comprising a beam entry window configured to pass the energy beam into the build chamber, and wherein the electrostatically charged plate is in a configuration to prevent the contaminants from depositing on the beam entry window.

4. The apparatus of claim 1, further comprising a first gas inlet configured to introduce a clean gas into the build chamber.

5. The apparatus of claim 4, further comprising a first gas outlet configured to remove at least a portion of a contaminated gas from the build chamber.

6. The apparatus of claim 1, wherein the electrostatically charged plate comprises a plurality of electrostatically charged plates.

7. The apparatus of claim 6, wherein the build chamber comprises a side wall and the plurality of electrostatically charged plates is coupled to the side wall.

8. The apparatus of claim 6, wherein at least one plate of the plurality of electrostatically charged plates is non-planar.

9. The apparatus of claim 6, further comprising a controller, wherein the controller is configured to provide a first voltage on a first plate of the plurality of electrostatically charged plates and provide a second voltage on a second plate of the plurality of electrostatically charged plates, and wherein the first voltage is different from the second voltage.

10. The apparatus of claim 6, wherein the plurality of electrostatically charged plates is positioned on or within the wall, and arranged in an offset configuration, a grid configuration, or a non-parallel configuration.

11. The apparatus of claim 10, wherein the offset configuration comprises the plurality of electrostatically charged plates is not horizontally aligned or is not vertically aligned.

12. The apparatus of claim 10, further comprising at least one gap between a first plate and a second plate of the plurality of electrostatically charged plates.

13. The apparatus of claim 6, wherein the build chamber further comprises a plurality of walls, wherein a top wall of the plurality of walls comprises a beam entry window configured to pass the energy beam into the build chamber, and the top wall further comprises a first plate of the plurality of electrostatically charged plates, and the apparatus further comprises:
a controller configured to provide a voltage to the first plate to repel the contaminants away from the beam entry window.

14. The apparatus of claim 13, wherein the wall comprises a second plate of the plurality of electrostatically charged plates, and wherein the controller provides a voltage to the second plate to attract the contaminants.

15. The apparatus of claim 1, further comprising a controller configured to change a voltage on the electrostatically charged plate such that the electrostatically charged plate changes from attracting the contaminants to repelling the contaminants, or from repelling the contaminants to attracting the contaminants.

16. The apparatus of claim 15, wherein the controller changes the voltage based on a material provided to the build chamber to form a build piece by a three dimensional (3-D) printer.

17. The apparatus of claim 16, wherein the material is an alloy.

18. A method for removing contaminants in a three dimension (3-D) printer comprising:
depositing material into a build chamber;
generating an energy beam;
applying the energy beam to the material, wherein the energy beam generates contaminants in the build chamber when applied to the material;
providing an electrostatically charged plate; and
applying a voltage to the electrostatically charged plate such that the electrostatically charged plate attracts or repels at least a portion of the contaminants in the build chamber.

19. The method of claim 18, wherein the build chamber comprises a wall, and the method comprises:
integrally forming the electrostatically charged plate with the wall.

20. The method of claim 18, wherein the build chamber comprises a wall, and the method comprises:
coupling the electrostatically charged plate to the wall.

21. The method of claim 18, further comprising:
coupling a beam entry window to the build chamber such that the beam entry window is configured to pass the energy beam into the build chamber; and
positioning the electrostatically charged plate in a configuration to prevent the contaminants from depositing on the beam entry window.

22. The method of claim 18, wherein the build chamber comprises a first gas inlet configured to introduce a clean gas into the build chamber.

23. The method of claim 22, wherein the build chamber comprises a first gas outlet configured to remove at least a portion of a contaminated gas from the build chamber.

24. The method of claim 18, wherein the electrostatically charged plate includes a plurality of electrostatically charged plates.

25. The method of claim 24, further comprising:
coupling the plurality of electrostatically charged plates to the wall.

26. The method of claim 24, wherein at least one plate of the plurality of electrostatically charged plates is non-planar.

27. The method of claim 24, further comprising:
providing a first voltage to a first plate of the plurality of electrostatically charged plates; and
providing a second voltage to a second plate of the plurality of electrostatically charged plates, wherein the first voltage is different from the second voltage.

28. The method of claim 24, further comprising:
positioning the plurality of electrostatically charged plates on or within the wall; and
arranging the plurality of electrostatically charged plates in one of: an offset configuration, a grid configuration, or a non-parallel configuration.

29. The method of claim 28, wherein the offset configuration comprises the plurality of electrostatically charged plates not positioned horizontally aligned or not positioned vertically aligned.

30. The method of claim 28, further comprising:
arranging a first plate and a second plate of the plurality of electrostatically charged plates such that at least one gap is between the first plate and the second plate.

31. The method of claim 24, wherein the build chamber further comprises a plurality of walls, wherein a top wall of the plurality of walls comprises a beam entry window configured to pass the energy beam into the build chamber, the top wall further comprises a first plate of the plurality of electrostatically charged plates, and a second plate is positioned on a wall of the plurality of walls, the method further comprising:
providing a voltage to the first plate to repel the contaminants away from the beam entry window.

32. The method of claim 31, further comprising:
providing a voltage to the second plate to attract the contaminants.

33. The method of claim 18, further comprising:
changing the voltage on the electrostatically charged plate such that the electrostatically charged plate changes from attracting the contaminants to repelling the contaminants, or from repelling the contaminants to attracting the contaminants.

34. The method of claim 33, wherein changing the voltage is based on the material provided to the build chamber.
